(19) United States
(12) Patent Application Publication
(10) Pub. No.: US 2005/0066037 A1
(43) Pub. Date: Mar. 24, 2005

(54) Browser session mobility system for multi-platform applications

(76) Inventors: Yu Song, Milpitas, CA (US); Hao-hua Chu, Mountain View, CA (US); Nayeem Islam, Palo Alto, CA (US); Masaji Katagiri, Los Altos, CA (US); Dan Rosen, San Francisco, CA (US); Shoji Kurakake, Yokohama (JP)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/404,849

(22) Filed: Apr. 1, 2003

Related U.S. Application Data
(63) Continuation-in-part of application No. 10/120,087, filed on Apr. 10, 2002.
(60) Provisional application No. 60/384,432, filed on May 31, 2002.

(51) Int. Cl. G06F 15/16

(52) U.S. Cl. 709/227

(57) ABSTRACT

A browser session mobility (BSM) system allows a user to save and restore the runtime state of active sessions of multi-platform network applications established with a browser. A platform specific runtime state of an active session with a browser that includes a current browser state and a current server state may be captured from a platform specific version of a multi-platform network application. The platform specific runtime state may be transformed to a platform independent runtime state and stored. The stored platform independent runtime state may be retrieved and transformed to another platform specific version of the multi-platform network application and instantiated as the same active session.

This is a continuation-in-part of U.S. patent application Ser. No. 10/120,087, filed Apr. 10, 2002. In addition, this application claims the benefit pursuant to 35 U.S.C. §119(e) of U.S. provisional patent application Ser. No. 60/384,342, filed on May 31, 2002, both of which are incorporated herein by reference

### FIELD OF THE INVENTION

The present invention relates generally to communication between devices on a network, and more particularly, to methods and systems that preserve the active state of one or more independent sessions initiated with a browser for later retrieval to continue the preserved session(s) with the same or a different browser and/or platform.

### BACKGROUND OF THE INVENTION

Utilization of the Internet to access information as well as for purchasing goods and services is common today. Typically, access to the Internet involves a browser. Browsers may be utilized to access websites over the Internet. Such websites include information and/or the capability to purchase goods and services. Interaction between browsers and websites is usually session oriented. Typically, websites require a browser to first establish a session and a session ID. The session ID may be used by a website to track and identify the browser as it moves between different pages within the website.

During an active web session, a browser may accumulate runtime state that is used to interact with the website over a stateless HTTP protocol. The runtime state of a browser can appear in cookies, document objects and script objects. The active web session is closed when the session expires. An active web session expires some time after the browser stops accessing the site, or when the user explicitly logs out. Once the active web session expires, some of the browser state is un-recoverable.

This session-oriented model inherently prohibits a user from maintaining the same active session when the browser that initiated the session is temporarily shut down. In addition, continuation of the same active session may not occur when a user desires to switch from a browser on one device to a different browser on a different device. For example, a user running an active session on a stationary device (such as a desktop PC) may not be able to interchange the stationary device with a mobile device (such as a Pocket PC with wireless access) without closing the active session on the stationary device and starting over with a new active session on the mobile device. Similarly, a user with an active session on a wireless device may not be able to preserve the session when the user elects to temporarily interrupt the wireless connection in an effort to minimize wireless airtime charges while performing other activities.

One well-known mechanism for accessing web pages with a browser involves utilization of bookmarks to save the uniform resource locators (URLs) of web pages for later access. The bookmarking concept, such as, for example, “Favorites” within Microsoft™ Internet Explorer™, provides efficient and quick access to web pages. Such bookmarking, however, provides only a return path to a static webpage. Since no session specific information, such as, for example, product selection criteria, purchasing information or any other information related to a particular active web session is preserved, such information must be recreated.

Another well-known mechanism for storing information related to an active session involves the use of cookies. In general, cookies are browser-side storage mechanisms that websites may use to store intra-session or inter-session information pertaining to a user operating a browser. Typically, cookies include information set by and later sent to the website being accessed by a browser. The cookies are transmitted to the device on which the browser is operating and stored therein. The browser may then include the previously stored cookie with each communication to the associated website. Since such cookies are associated with, and stored on, a single device, the cookies are not accessible to browsers operating on other devices.

Yet another well-known mechanism provided by some websites identifies the user of the browser and saves purchasing information accumulated during an active session. The information is stored in a server-side database for retrieval in a later session. Not only do these techniques require significant user tracking capability at each website, but also place burdens on users to complete a sign-in process before any decision to purchase goods or services is contemplated. In addition, the purchasing information saved by such websites does not include information related to the active session, such as, for example, the previous pages displayed by the browser, values customized during the session and/or any other information related to browser navigation and related customization within the website. Accordingly, much of the research and customization from a previous active session must be recreated once a new session with the website is initiated.

### SUMMARY

The present invention includes a browser state mobility (BSM) system. The BSM system supports capture, preservation and re-instantiation of an active session. Active sessions may be established between an application server and a browser operating on a communication device representative of a platform. The active session may be supported by the application server with a platform specific version of a multi-platform network application. Establishment of an active session results in a platform specific state or runtime state. The platform specific state may be captured as a snapshot, selectively transformed to create a platform independent state and stored within a repository server included in the BSM system. Capture and transformation of the state may include the capture and selective transformation of a current browser state and a corresponding current server state of the active session. Alternatively, only the current browser state may be captured, selectively transformed and stored.

The BSM system supports mobility of multi-platform network applications among heterogeneous platforms with the platform independent state. Upon retrieval from storage, a platform independent state may be transformed to any platform specific state as a function of the device platform and browser requesting retrieval. Accordingly, a first platform specific state of an active session may be captured from a first platform specific version of a network application and selectively transformed to create a platform independent state. The platform independent state may be stored, later retrieved, and selectively transformed to a second platform specific state. The second platform specific state may be instantiated as the same active session with a second platform specific version of the network application.

Platform specific states and platform independent states may be represented within the BSM system with snapshots. A platform specific (PS) snapshot may represent a platform specific state of at least one of a browser side state and a server side state. A platform independent (PI) snapshot may be representative of a platform independent state. Each of the snapshots may include state data and session data representative of an active session. Transformation between the PI snapshots and the PS snapshot(s) may be performed based on mapping. The mapping may provide selective transformation of those portions of platform specific states that may be different among different platform specific versions of the same network application.

The BSM system is therefore capable of decoupling the traditional association between the browser running state and a device on which the browser operates. Instead, the BSM system creates an association between the browser running state and a user by storing a PI snapshot(s) of the running state in a user accessible location. In addition, the BSM system effectively decouples the association between the state of an active session and a particular platform. The association between a particular platform and the state is decoupled by capturing and selectively transforming a state that may include both a server side state and a browser side state to create a platform independent state. Alternatively the platform independent state may include only the browser side state. The platform independent state may be re-instantiated on any other platform by selective transformation to a platform specific state.

An interesting feature of the BSM system relates to transformation between a PS snapshot and a PI snapshot. Once a browser side state, for example, is captured in a PS snapshot, state data and/or session data representative of the state within the PS snapshot may be selectively transformed to create a PI snapshot. The transformation may be performed using a mapping description file to selectively direct the transformation. The mapping description file may identify state data and/or session data within the PS snapshot that is platform specific and provide transformation of the identified state and session data to platform independent state and session data.

Another interesting feature of the BSM system involves the generation of a PI snapshot. The PI snapshot may be representative of the platform independent state of an entire active session by aggregating the server side state with the browser side state. Following selective transformation of the server side state to create a PI snapshot, the browser side state may be selectively transformed and aggregated with the server side state in the same PI snapshot. Alternatively, only the browser side state may be captured and selectively transformed to create a PI snapshot.

Yet another interesting feature of the BSM system involves the configuration of the mapping between states in the different snapshots. The mapping may be selectively configured to transform significant portions of the state data and session data captured within a snapshot, only small portions of the state and session data or none of the state and session data. The amount of transformations specified in the mapping may be a function of the compatibility of the captured state and session data with different platforms. Where state and session data within a snapshot is compatible with multiple platforms, no transformation may be specified in the mapping. If on the other hand, portions of the state and session data within a snapshot are not compatible, mapping may specify the appropriate transformations.

Still another interesting feature of the BSM system involves the mapping between the state and session data in the different snapshots representative of the running state of an active session. Mapping for different platforms may be contained in mapping description files. The selection of which mapping description file to use for a particular platform may be identified with a master mapping file. Once a platform is identified, the master mapping file may be used to identify the corresponding mapping description file that should be utilized to selectively transform the state and session data contained within a snapshot.

Further objects and advantages of the present invention will be apparent from the following description, reference being made to the accompanying drawings wherein preferred embodiments of the present invention are clearly shown.

### BRIEF DESCRIPTION OF THE DRAWINGS

FIG. 1 is a block diagram of a browser state repository (BSR) service.

FIG. 2 is a more detailed block diagram of the BSR service illustrated in FIG. 1 and includes a site.

FIG. 3 is a more detailed block diagram of a browser state repository (BSR) device module illustrated in FIG. 2.

FIG. 4 is an example of a user interface bar activatable by the BSR device module illustrated in FIG. 3.

FIG. 5 is another example of a user interface bar activatable by the BSR device module illustrated in FIG. 3.

FIG. 6 is a more detailed block diagram of a browser state repository (BSR) repository module illustrated in FIG. 2.

FIG. 7 is a flow diagram illustrating an operational example of the BSR service.

FIG. 8 is a second portion of the flow diagram illustrated in FIG. 7.

FIG. 9 is a flow diagram illustrating an operational example of the BSR service.

FIG. 10 is a block diagram of a browser state mobility (BSM) system.

FIG. 11 is an example presentation on a browser/platform within the BSM system of FIG. 10.

FIG. 12 is a second example presentation on a browser/platform within the BSM system of FIG. 10.

FIG. 13 is a third example presentation on a browser/platform within the BSM system of FIG. 10.

FIG. 14 is a more detailed block diagram of a browser state mobility (BSM) device module illustrated in FIG. 10.

FIG. 15 is a more detailed block diagram of a browser state mobility (BSM) repository module illustrated in FIG. 10.

FIG. 16 is a flow diagram illustrating an operational example of the BSM system of FIG. 10 during capture, transformation and save of an active session.

FIG. 17 is a second portion of the flow diagram illustrated in FIG. 16.

FIG. 18 is a flow diagram illustrating an operational example of the BSM system of FIG. 10 during restoration of an active session on a different platform.

### DETAILED DESCRIPTION

The invention includes a browser state repository (BSR) service that allows a user operating a browser to save browser states from one or more active sessions. The BSR service allows the user to later selectively retrieve any of the saved browser states with any browser and/or any device to continue the same corresponding active session. The running state of the browser may be restored to the same point in the active session at which the browser state was saved. Accordingly, the BSR service may allow users to switch to a new device/browser in the middle of an active session without losing the browser state of the active session and having to start over with a new browser state on the new device. In addition, the BSR service may allow a user to keep track of browser states from multiple active sessions simultaneously, as well as the ability to save and later continue any active session(s) from any device/browser.

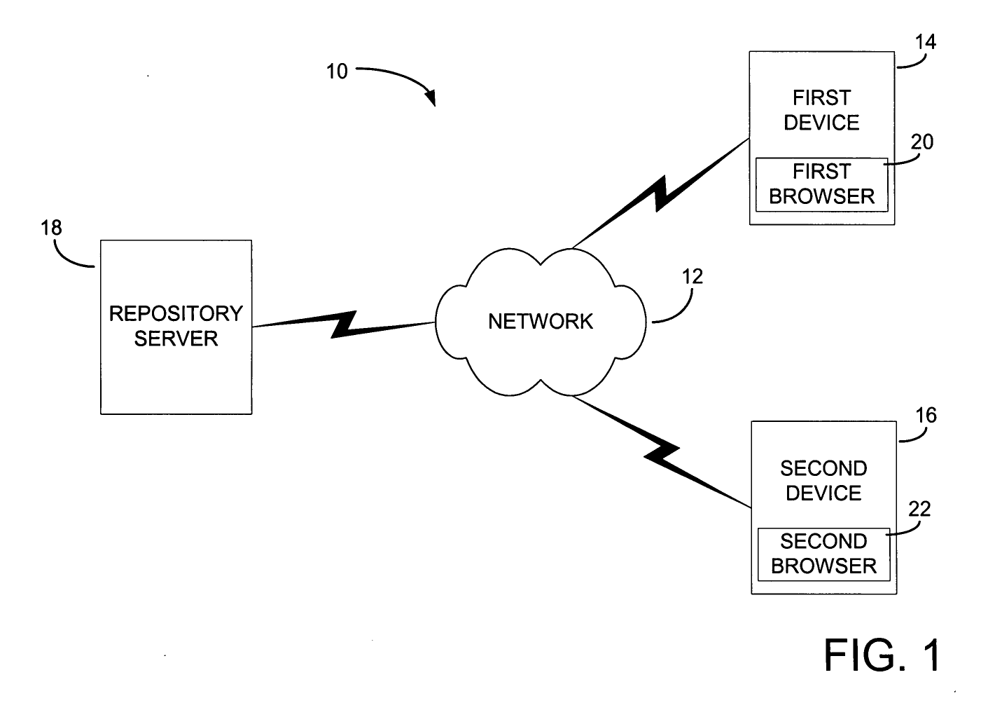

FIG. 1 is a block diagram of one embodiment of the BSR service 10 operating over a network 12. The BSR service 10 includes at least one device illustrated as a first device 14 and a second device 16. In addition, the BSR service includes at least one repository server 18. The first and second devices 14, 16 and the repository server 18 are communicatively coupled via the network 12 as illustrated in FIG. 1. In other embodiments, the BSR service 10 may include any number of devices, repository servers and/or any other network compatible devices. As used herein, the term “coupled”, “connected”, or “interconnected” may mean electrically coupled, optically coupled, wirelessly coupled and/or any other form of coupling providing an interface between systems, devices and/or components.

The network 12 may include the Internet, a public and/or private intranet, an extranet, and/or any other form of network configuration to enable transfer of data and commands. Communication within the network 12 may be performed with a communication medium that includes wireline based communication systems and/or wireless based communication systems. The communication medium may be for example, a communication channel, radio waves, microwave, wire transmissions, fiber optic transmissions, or any other communication medium capable of transmitting data, audio and/or video information.

The first and second devices 14, 16 may be any type of computing device or similar hardware capable of providing a connection for communication over the network 12. In addition, the first and second devices 14, 16 may include a user interface (UI), memory, a microprocessor and/or any other hardware and associated operating systems/applications. For example, the first and second devices 14, 16 may be wireless devices, such as, a wireless phone, a personal digital assistant (PDA), a pocket personal computer (PC) or any other device capable of wireless communication. In addition, the first and second devices 14, 16 may be wireline devices, such as, for example, a network terminal, a personal computer, a server computer or any other device capable of wireline communication over the network 12. In other embodiments, the first and second devices 14, 16 may include both wireline and wireless communication capabilities.

As further illustrated in FIG. 1, operating on the first device 14 is a first browser 20. Similarly, a second browser 22 may operate on the second device 16. The first and second browsers 20, 22 may be any form of application running on the first and second devices 14, 16 capable of locating and displaying pages downloaded from other devices in the network 12. In the presently preferred embodiments, the first and second browsers 20, 22 are web browsers, such as, for example, Microsoft™ Internet Explorer™ and/or Netscape Navigator™. In other embodiments, the first and second browsers 20, 22 may be any other form of homogeneous or heterogeneous browsers with the functionality to locate and display any form of pages downloaded over the network 12. In addition to displaying text and graphics, the first and second browsers 20, 22 may also support the presentation of video, audio, multimedia and/or any other information. Operation of the BSR service 10 is also preferably supported by the first and second browsers 20, 22. The first and second browsers 20, 22 may be launched and operated on the first and second devices 14, 16 to cooperatively operate with the repository server 18.

The repository server 18 may be any form of computing device, such as, for example, at least one server, capable of receiving requests and transmitting responses over the network 12. In the illustrated embodiment, the repository server 18 may operate within the infrastructure of the BSR service 10 to monitor requests from, and transmit responses to, the first and second browsers 14, 16. In one embodiment, the repository server 18 is a hypertext transfer protocol (HTTP) server. In this embodiment, the first and second browsers 14, 16 may use HTTP and/or secure HTTP (HTTPS) for communication with the repository server 18. In other embodiments, other protocols, such as, file transfer protocol (FTP), network news transfer protocol (NNTP), simple mail transfer protocol (SMTP), remote message interface (RMI), common object request broker architecture (CORBA), public and private proprietary protocols or any other protocol may be used.

During operation of the BSR service 10, a user may establish an active session utilizing the first browser 20 operating on the first device 14. The term “active session” refers to any form of interaction with another device on the network 12 in which information provided by the other device is displayed, communicated, or otherwise conveyed to a user operating the first browser 20. An exemplary active session is a web session in which web pages and associated materials may be located, downloaded and displayed with the first browser 20.

Following establishment and customization of the active session, the user may capture and store a current browser state of the active session using the BSR service 10. As used herein, “customize” or “customization” of an active session includes any changes to the active session resulting from interactions with the first browser 20 that accumulates in the state of the active session. Further, the term “current browser state” or “browser state” represents the customized state of the active session a user has created with a browser. The captured current browser state of the active session may be referred to as a “snapshot” or a “browser snapshot” since the current running state of the active session on the first browser 20 and attributes associated therewith may be captured in a storable format.

The current browser state of the active session may include the browser cache and the browser history. The browser cache and the browser history may include, for example, the last page displayed by the first browser 20 as well as the current state of document objects and scripting objects. Accordingly, pages within the captured current browser state of the active session may be dynamic or static. In addition, the browser cache and the browser history may include values modified/entered on previous pages and/or the last page, an ordered list of previously-viewed pages, cookies and/or any other parameters associated with the current state of the active session that are customizable by the user. The user may securely store the current browser state of the active session within the network 12 using the repository server 18.

The BSR service 10 allows the user to securely retrieve the stored current browser state of the active session at a later time. The user may retrieve the stored current browser state with the repository server 18 and any browser on any device. For example, the user may use the first browser 20 on the first device 14, the second browser 22 on the second device 16 or any other device and associated browser. Upon retrieval of the stored current browser state, the browser state of the active session may be restored such that the same active session may be continued from the point at which the snapshot was taken.

For example, consider a user operating the first browser 20 with a desktop PC at the office to shop for window draperies. Following successive composition of a number of choices of preferred colors, patterns and styles on different pages during an active session, the user must go home to measure the windows. Similarly, the same user may use the first browser 20 in another active session to successively compose a number of different possible flight itineraries on different pages in an active session with the intent of later purchasing an airline ticket.

Using the BSR service 10, the user may capture the current browser state of each of these customized active sessions prior to shutting down the first browser 20. The user may then go home, measure windows, finalize travel plans and launch the second browser 22 on the second device 16 such as, for example, a pocket PC. Following retrieval and restoration of the previously stored browser snapshots, the user may browse the previously customized pages in the active session and finalize a selection of draperies. In addition, the user may browse the previously customized pages and choose one of the flight itineraries composed in the earlier customized active session.

In one embodiment, the BSR service 10 is deployed within the infrastructure and associated protocols of the Internet. In this embodiment, deployment requires relatively little modification to existing websites, devices and associated browsers. In other embodiments, the BSR service 10 may be deployed in any other infrastructure with any other associated protocols.

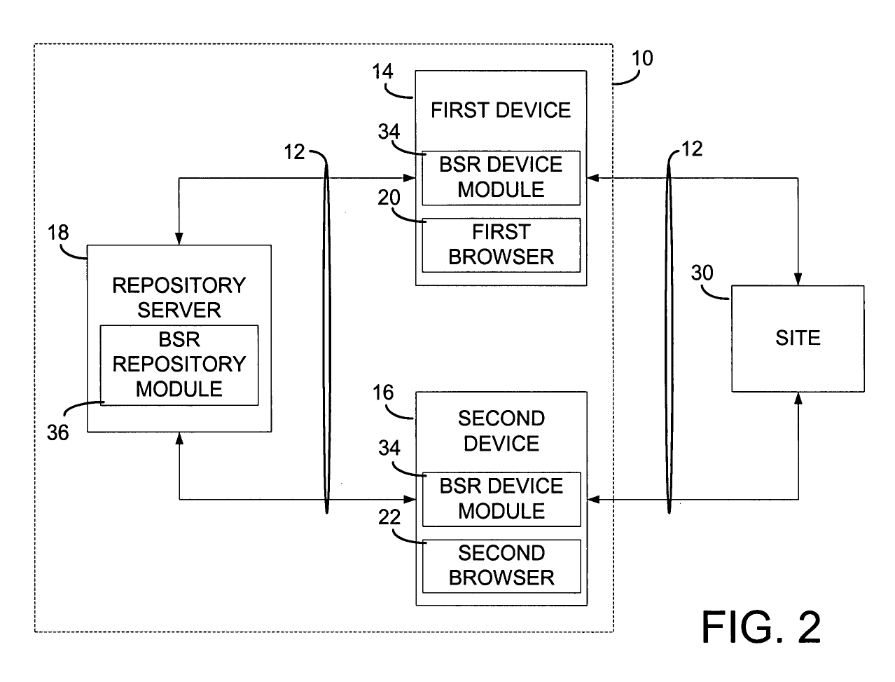

FIG. 2 includes a more detailed block diagram of one embodiment of the BSR service 10. Similar to the embodiments described with reference to FIG. 1, the BSR service 10 includes the first device 14 with the first browser 20, the second device 16 with the second browser 22 and the repository server 18 communicating over the network 12 as illustrated. FIG. 2 also depicts at least one site 30 in communication with the repository server 18 and the first and second devices 14, 16, respectively, over the network 12. As further shown in FIG. 2, portions of the infrastructure of the BSR service 10 of this embodiment are illustratively depicted as a BSR device module 34 operating within the first and second devices 14, 16, and a BSR repository module 36 operating within the repository server 18. In other embodiments, any number of secure and/or non-secure sites may be included. In addition, fewer or greater numbers of modules may be illustrated to represent portions of the BSR service 10.

The site 30, on the other hand, may be any mechanism communicating over the network 12 capable of providing access to information via a browser. The site 30 may be a non-secure site without any form of security to minimize the possibility of unauthorized access, or may be a secure site. Accordingly, the first and second browsers, 20, 22 may browse the site 30 using secure communications or non-secure communications depending on the level of security that is present. For example, the first and second browsers 20, 22 may communicate with HTTP messages when the site 30 is a non-secure site and with HTTPS messages when the site 30 is a secure site. In other embodiments, the site 30 may include portions representative of a secure site and other portions representative of a non-secure site. In these embodiments, communications may shift between secure communications and non-secure communications depending on the portion of the site being browsed.

The BSR device module 34 may be any application launched on at least one of the first and second devices 14, 16 to enhance or otherwise cooperatively operate with the first and second browsers 20, 22, respectively, in support of operation of the BSR service 10. In the presently preferred embodiments, the BSR device module 34 is a downloadable browser plug-in which may be applied to the first and second browsers 20, 22. In general, a browser plug-in is a well-known type of application which adds capabilities or services to a larger application. In other embodiments, the BSR device module 34 may be a standalone module within each of the first and second devices 14, 16 operating to enhance the operation of the first and second browsers 20, 22, respectively.

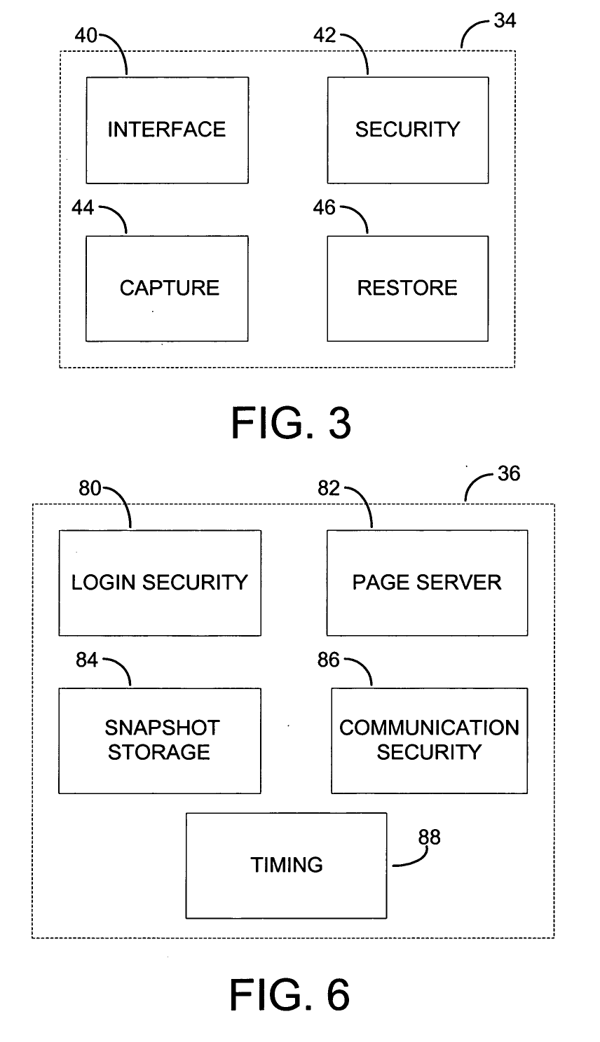

FIG. 3 is a block diagram depicting one embodiment of the BSR device module 34. In the illustrated embodiment, the functionality of the BSR device module 34 includes an interface component 40, a security component 42, a capture component 44 and a restore component 46. In other embodiments, additional functionality, such as, for example, snapshot storage capability, user verification capability or any other functionality associated with the BSR service 10 may be included in the BSR device module 34.

The interface component 40 provides an interface with the BSR service 10 for users of the first and second devices 14, 16. Utilizing the interface, a user may direct operation of additional functionality provided by the BSR device module 34 as well as the functionality of the BSR service 10. In addition, the interface component 40 may provide a transformation function to conform the user interface to the physical hardware of a particular device. For example, on one device the user interface may be a touch screen, on another device the user interface may be buttons and on yet another device the user interface may be audio/video interaction. Accordingly, the interface component 40 may sense the device hardware and transform the user interface to be compatible with the hardware.

The security component 42 may provide security to selectively maintain secure communications and avoid unauthorized utilization of the BSR service 10. The capture component 44 allows a user to take a browser snapshot of a current active session and store the snapshot. Similarly, the restore component 46 allows a user to direct the retrieval of a stored browser snapshot. A detailed discussion of the functionality of the components of the BSR device module 34 are hereinafter described.

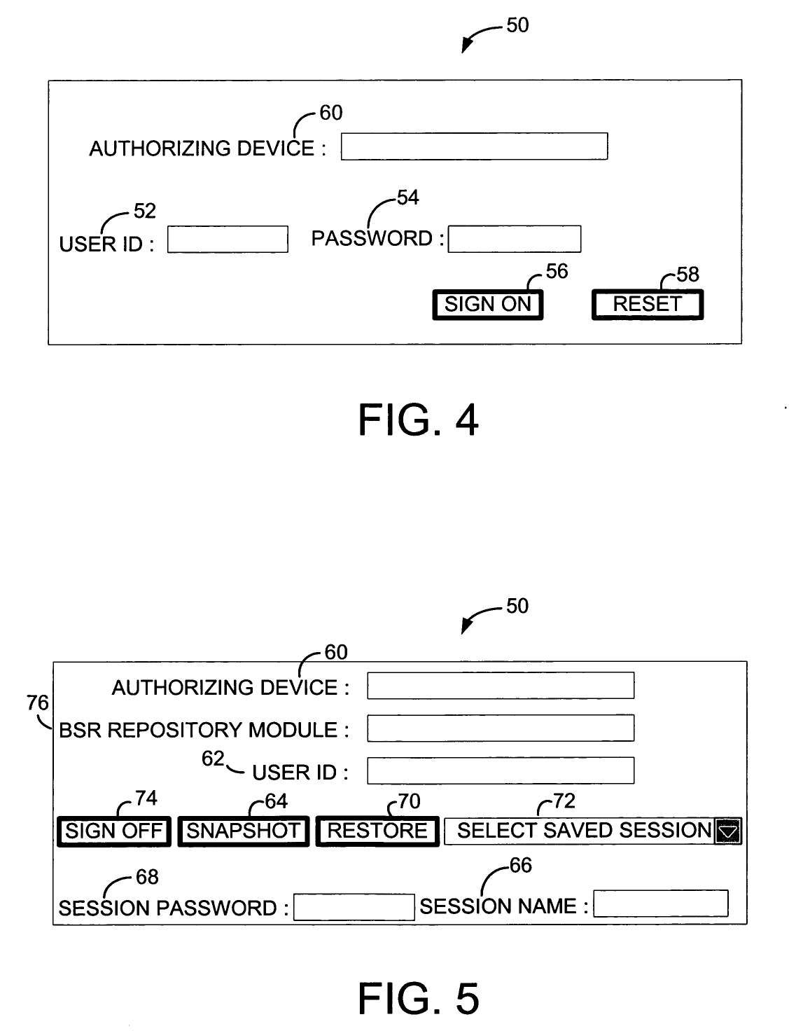

FIGS. 4 and 5 illustrate embodiments of an interface in the form of a user interface bar 50. The user interface bar 50 may be activated and maintained with the interface component 40 (FIG. 3). In one embodiment the user interface bar 50 may be displayed within a browser window of a graphical user interface (GUI) of the first and second devices 14, 16 (FIG. 2). In other embodiments, the user interface bar 50 may be displayed within a separate window or as a separate page. In still other embodiments, the selectable features (hereinafter described) of the user interface bar 50 may be represented by hard buttons, individual icons, voice recognition and/or any other mechanism allowing a user to interface with and direct the functionality of the BSR service 10 (FIG. 2).

Once the interface module 40 is activated, the user interface bar 50 of the presently preferred embodiments may display at least one hypertext markup language (HTML) page. In these embodiments, the page(s) may be served from the repository server 18 (FIG. 2) on which the BSR repository module 36 (FIG. 2) is operating. Accordingly, relatively few modifications/additions are needed to the architecture of the first and second browsers 20, 22 to implement the interface component 40.

In other embodiments, the page(s) may be, for example, an extensible markup language (XML) page, a wireless markup language (WML) page, a compact hypertext markup language (CHTML) page and/or a page represented by any other language. In addition, the page(s) may be served from any other device within the network 12 in cooperative operation with the interface component 40. In still other embodiments, the user interface bar 50 may be independently generated and maintained by the interface component 40. In these embodiments, the interface component 40 may decipher and communicate commands and information over the network 12 (FIG. 2) as a function of commands entered via the user interface bar 50.

The embodiment illustrated in FIG. 4 depicts the user interface bar 50 as a login screen that includes a user ID entry 52, a password entry 54, a sign on button 56, a reset button 58, and an authorizing device ID 60. In other embodiments, any other user identification related functionality may be included in the login screen of the user interface bar 50. The login screen allows a user to enter login information. The login information may be used to prevent a user access to the BSR service 10 (FIG. 2) without first being authenticated and obtaining authorization.

Referring now to FIGS. 2, 3 and 4, in the presently preferred embodiments, authentication and authorization is provided by the BSR repository module 36. In these embodiments entry of a user name in the user ID entry 52 along with a password in the password entry 54 are transmitted over the network to the BSR repository module 36 for authentication and authorization. The security component 42 may initiate the establishment of a secure connection, such as, for example, a secure sockets layer (SSL) connection, with the BSR repository module 36 to begin the authentication and authorization process. Initiation of a secure connection by the security component 42 may involve identifying the user name and password information as secure by, for example, making the information an HTTPS message. The login screen of these embodiments is preferably served from the repository server 18 on which the BSR repository module 36 is operating. In addition, the establishment of the secure connection is provided with the first and second browsers 20, 22.

The security component 42 may also operate in conjunction with the interface component 40 to maintain the functional operation of the login screen. For example, initiation of the authentication and authorization process by the security component 42 may occur when the sign on button 56 is activated. In addition, subsequent messages sent over the network from the BSR device module 34 to the BSR repository module 36 may be identified as secure messages by the security component 42. In other embodiments, login information may be provided to the security component 42 externally by data from a personal information storage device (such as a personal information card), a biological scanner (such as a voice, fingerprint or retina scanner) and/or any other mechanism for identifying a user. In still other embodiments, the security component 42 may generate the login screen as well as provide authorization to allow a user access to the functionality of the BSR service 10. In yet another embodiment, the security component 42 may provide a level of local security such as, for example, a time out password when the user interface bar 50 is inactive for extended periods.

The authorizing device ID 60 identifies at least one device within the network 12 to which login information may be submitted for authentication of the identity of the user. The device(s) may be any network-connected device(s) with the capability to compare information from a user created account to login information transmitted via the security component 42. In the presently preferred embodiments, users may create an account with the BSR repository module 36. Accordingly, the authorizing device ID 60 of this embodiment may include an identifier of the repository server 18 within which the BSR repository module 36 operates. The identifier may be, for example, an Internet Protocol (IP) address, a uniform resource locator (URL), a uniform resource identifier (URI), a universal unique identifier (UUID) or any other form of identifier.

As illustrated in the embodiment of FIG. 5, the user interface bar 50 may also represent a user screen for interfacing with the BSR service 10. The user interface bar 50 of this embodiment includes the authorizing device ID 60, a user ID indication 62, a snapshot button 64, a session name field 66, a session password field 68, a restore button 70, a session selection field 72, a sign-off button 74 and a BSR repository module indication 76. In other embodiments, additional functionality and information related to operation of the BSR service 10 may be included in the user interface bar 50.

Referring now to FIGS. 2, 3 and 5, the user screen of this embodiment may be displayed in the user interface bar 50 following authentication and authorization of login information supplied by a user. Accordingly, the user ID indication 62 may identify the successfully logged in authorized user. Identity may include, for example, a user name, a number or any other indication of the currently authorized user.

The snapshot button 64 provides a user the ability to activate the capture component 44 within the BSR device module 34. As previously discussed, the capture component 44 provides the capability to take a snapshot or otherwise capture the current browser state of an active session. When a snapshot is initiated, the capture component 44 captures a plurality of session parameters related to the browser state of the current session. In one embodiment, the session parameters may include at least one document object model (DOM) representative of a current page(s) being displayed in the browser, scripting objects of the current page(s), a browser history, a browser cache and cookies of the current session. In other embodiments, any other forms of session parameters representative of the current active state of the session may be captured by the capture component 44.

As known in the art, DOM includes a set of application programming interfaces (APIs) for valid HTML and XML documents. In general, the DOM defines an abstract logical structure for documents, and includes standard interfaces for access and manipulation of documents displayed in browsers. The interfaces defined by DOM may be used to build, traverse, and modify a document structure along with the elements contained therein.

For example, when an HTML page is parsed with a Microsoft™ Internet Explorer™ browser, a DOM structure is created. The DOM structure may represent the structure of an HTML page in the browser. Each node in the DOM structure may represent document information. The document information may include, for example, HTML elements, XML elements, attributes and/or text from the HTML page. For example, the HTML fragment <a href-htt=://www.docomolabs-usa.com>DoCoMo</a> may be represented as four DOM nodes: a node for the “a” element, a node for the “href” attribute and two nodes for the textual content.

As known in the art, a set of properties describing the presentation and behavior within a browser may be included in each node of the DOM structure. The BSR device module 34 may be directed to capture such a DOM structure, including content and node properties, in a session snapshot. In other embodiments, browsers with different capabilities such as, for example, compact HTML (cHTML), wireless application protocol (WAP), wireless markup language (WML) and/or any other protocol/language may be used to create a structure that may be captured by the BSR device module 34.

Following download of a page into, for example, a Microsoft™ Internet Explorer™ browser, the current browser state of an active session may be preserved with the BSR service 10. When a user activates the snapshot button 64, the capture component 44 may proceed through all document objects inside a top-level frame of the current page in the browser. The capture component 44 may capture each node element and associated properties within the top-level frame. In addition, the capture component 44 may recursively proceed down through lower level frames to capture additional node elements and properties of the DOM structure.

Another session parameter that may be captured by the capture component 44 is a scripting object(s). Scripting objects such as, for example, VB Script and JavaScript may also be included in a page(s) downloaded into a browser. The capture component 44 may capture such scripting object(s) as part of a browser snapshot. The scripting objects may be captured along with the DOM document. Accordingly, the capture component 44 may capture both the DOM and the scripting object(s) representative of the current page. Alternatively, the scripting objects may be separately captured by the capture component 44.

With, for example, a Microsoft™ Internet Explorer™ browser, script variables may be defined in script tags represented as IDispatch objects. The IDispatch objects may be accessed at runtime through a script engine provided within the Microsoft™ Internet Explorer™ browser. When a snapshot is captured from a Microsoft™ Internet Explorer™ browser, the capture component 44 may serialize and captured the IDispatch objects corresponding to the script variables.

Yet another session parameter that may be captured by the capture component 44 is cookies. Generally, cookies are well-known device identifiers that may include user specific information. As known in the art, cookies may be provided to browsers along with pages downloaded into the browser. The capture component 44 may interpret and save cookies in name/value pairs as part of the capture process. The cookies may be captured and appended to the other information captured by the capture component 44. Where the Microsoft™ Internet Explorer™ browser is used, the cookies may be appended after the previously discussed DOM structure within each snapshot.

Still another session parameter that may be captured by the capture component 44 is the browser history of an active session. The browser history is a compilation of previous pages to which a browser has visited. Accordingly, the capture component 44 may capture and append the pages identified in the browser history to the other captured information. In embodiments operating with the Microsoft™ Internet Explorer™ browser, an IURLHistoryStg interface is included to retrieve and set a URL history in the browser. In these embodiments, capturing the browser history involves iterating over the URL history, fetching identified URLs, and appending the fetched URLs to follow the DOM structure and cookies.

The capture component 44 may provide the user an opportunity to establish a session name and a session password for the captured current browser state of an active session. The user may enter a unique session name in the session name field 66 illustrated in FIG. 4. Alternatively, the user may select an existing session name from a previously captured browser state. Where no session name is provided a default session name, such as, for example the host name of a website may be generated to identify the captured browser state of the active session.

The user may also have the option of protecting the browser snapshot with a session password entered in the session password field 68 illustrated in FIG. 4. The session password offers additional security to avoid unauthorized access to a captured browser snapshot. In other embodiments, entry of the session password may involve an audio password or any other mechanism for providing secure access to the browser snapshot.

Once captured, a browser snapshot may be associated with the user initiating the capture. Accordingly, the snapshot is associated with the user and not the browser and/or device from which the active browser state was captured. Association with the user may include identifying the snapshot with account information of a user's account, a user name or any other mechanism for uniquely identifying the user who customized the active session and captured the browser snapshot. The browser snapshots associated with each user may be stored in a secure location within the network 12.

In the presently preferred embodiments, storage may occur at the BSR repository module 36. In these embodiments, the security component 42 may initiate establishment of a secure connection between the BSR device module 34 and the BSR repository module 36 to transmit the captured browser state of the active session over the network 12. In other embodiments, where the captured browser state of the active session is stored elsewhere in the network 12, the security component 42 may initiate a secure connection with any other network connected device to allow secure transmission of the browser snapshot.

In one embodiment, storage of a browser snapshot may occur automatically following entry of a session name and session password. In other embodiments, the user may initiate storage with a separate command and/or selection of a storage location. If the user continues customizing the active session following initiation of a browser state capture, the capture component 44 may generate a warning of the potential for inconsistency with the captured browser snapshot that has been stored for the active session.

As previously discussed, the BSR device module 34 also includes the restore component 46. Stored browser snapshots may be retrieved at the direction of a user using the user interface bar 50. Retrieval may be initiated with the restore button 70 and the session selection field 72. Following successful authentication and authorization, a user may select previously stored browser snapshots associated with that user. Selection may involve a pull down menu list, an index, a database, manual entry of a session name, or any other look up mechanism for identifying a list of browser snapshots captured and associated with that user. The look up mechanism and/or the list may be provided by the BSR repository module 36, the security component 42 and/or any other device associated with the storage location of the browser snapshots.

Once a previously captured and stored browser state for the active session is selected, retrieval may be initiated with the restore button 70. In one embodiment, where the browser state of the active session is stored at the BSR repository module 36, the stored browser snapshot may be downloaded over the secure connection previously established to authorize and authenticate the user during the login process. In this embodiment, if the secure connection no longer exists, the security component 42 may again initiate establishment of the secure connection. In another embodiment, where the browser snapshot is stored elsewhere in the network 12, the security component 42 may initiate a secure connection to allow secure retrieval.

If a session password is associated with the selected stored browser snapshot, the session password may be entered in the session password field 68. The session password may be authenticated with the BSR repository module 36, the security component 42 or any other device associated with the storage location of the browser snapshots. Accordingly, without a session password, users may not be able to retrieve a saved browser snapshot following successful login verification and authorization.

Following receipt, the restore component 46 may restore the browser snapshot. Restoration of the browser snapshot involves conversion of the browser snapshot back into a browser state of an active session. Upon restoration, the active session may be displayed by the browser in the same condition as when the snapshot was initiated. Display of the browser state of the active session in one embodiment results from restoration of the previously captured DOM and scripting objects as earlier described. In addition, values entered on other pages, the browser history, the browser cache, cookies and/or any other information customized during the active session may also be restored.

In one embodiment, the restoration involves re-downloading content from the site 30 (FIG. 2). After the content is downloaded into the browser from the site 30, the restore component 46 of the BSR device module 34 may utilize the browser snapshot to customize the content thereby restoring the previously stored browser state of the active session. In one embodiment, the DOM structure of the downloaded content may be utilized in restoration of the previously capture DOM structure. In this embodiment, the restore component 46 may restore the values and the properties of each DOM node in the downloaded content according to the previously captured DOM structure. After the DOM structure is restored, the restore component 46 may proceed with restoration of cookies, script object variable values and browser history.

Referring again to FIGS. 2, 3 and 5, the sign-off button 74 represents additional functionality provided within the security module 42. The security module 42 may initiate the log off process, or otherwise terminate user access to the BSR service 10 when the sign-off button 74 is activated. Upon activation of the sign-off button 74, the security module 42 may disconnect the BSR device module 34 from the associated browser. In addition, the security module 42 may direct the interface component 40 to deactivate and close the user interface bar 50.

The BSR repository module indication 76 may indicate the location of the device upon which the BSR repository module 36 is operating. The location indication may be an IP address, a physical location or any other form of unique identifier. Accordingly, where there are a number of BSR repository modules 32 available, the BSR repository module indication 76 may allow selection of a desired location.

Referring once again to FIG. 2, the BSR repository module 36 may be any application operating on a device capable of communication with the BSR device module 34 over the network 12, and supporting operation of the BSR service 10. In the presently preferred embodiments, the BSR repository module 36 operates within the repository server 18. In other embodiments, the BSR repository module 36 may operate within any other network-connected device. In the illustrated embodiment, the repository server 18, operating in conjunction with the BSR repository module 36, may be a commercial provider of server services, or a privately configured and maintained source of server services for the BSR service 10.

FIG. 6 is a block diagram of one embodiment of the BSR repository module 36. The BSR repository module 36 includes a login security component 80, a page server component 82, a snapshot storage component 84, a communication security component 86 and a timing component 88. In other embodiments, the functionality of the BSR repository module 36 may be illustratively depicted in greater or fewer numbers of components. In still other embodiments, the BSR repository module 36 may include transcoding services. The transcoding services may allow translation from one language to another language, such as, transcoding HTML to compact HTML (cHTML), cHTML to HTML, and/or any other possible language translations. In addition, the transcoding services may allow translation from one protocol to another, such as, translating between HTTP and wireless application protocol (WAP). Further, transcoding may involve translation of both language and protocol, such as translating HTML on HTTP to wireless markup language (WML) on WAP and back.

The login security component 80 may provide authentication and authorization of a user who provides login information through the login screen of the user interface bar 50 previously described with reference to FIG. 4. The login security component 80 may operate to compare information in an account to the login information provided via the user interface bar 50. The account may be established and stored with the BSR repository module 36 by a user. Upon receipt of login information, the login security component 80 may access stored account information to authenticate the identity of a user. Following successful authentication, the user may be logged in and allowed access to the BSR repository module 36.

The page server component 82 may allow the BSR repository module 36 to function as a standard host serving documents to the user interface bar 50 as previously discussed with reference to FIGS. 4 and 5. In addition to documents, the page server component 82 may provide any other information related to the user identified with the login information. For example, a list of previously saved browser snapshots may be provided to the session selection field 72 as previously discussed. The list of saved browser snapshots may identify snapshots stored with the BSR repository module 36. In other embodiments, the page server component 82 may provide information within pages generated and displayed by other mechanisms, such as, for example, the interface component 40 (FIG. 3) or any other device in the network 12 (FIG. 2).

The snapshot storage component 84 may store browser snapshots captured by the BSR device module 34 as previously discussed with reference to FIGS. 3 and 5. Upon transmittal of a browser snapshot by the capture component 44 (FIG. 3), the snapshot storage component 84 may receive and archive the snapshot. The snapshot storage component 84 may direct the storage of browser snapshots in a storage mechanism associated with the device the BSR repository module 36 is operating within.

An exemplary storage mechanism includes a relational database operating in conjunction with a computer hard drive, an optical disc or any other data storage medium. In other embodiments, the snapshot storage component 84 may direct the storage of browser snapshots in any other storage mechanism in any other device within the network 12 (FIG. 2).

As previously discussed, each of the archived browser snapshots may be associated with the user who initiated the capture and storage of the browser states of the active sessions. Accordingly, the snapshots may be stored according to the identity of the user. In addition, access to the archived snapshots may be based on authentication of the identity, and authorization, of the user who initiated the capture and storage of the browser states.

Previously archived browser snapshots may be accessed by the snapshot storage component 84 based on the authentication and authorization of the user along with the user's identification of the requested snapshot. As previously discussed with reference to FIG. 5, an archived browser snapshot may be identified for retrieval with the session selection field 72 of the user interface bar 50. Selected browser snapshots may be retrieved from the storage mechanism and forwarded to the browser of the user for restoration and display as previously described. The snapshot component 84 may also perform password verification of the password associated with a selected stored browser snapshot.

Referring now to FIGS. 2 and 6, the communication security component 86 may provide secure communication with the BSR device module 34. The secure communication may involve any of the previously discussed protocols. Secure communication may involve, for example, the transmittal of login information, the transmittal of captured browser states from active sessions or any other communication between the BSR device module 34 and the BSR repository server 36. In addition, communication of any other sensitive information related to the BSR service 10 may be made secure using the communication security component 86.

The timing component 88 may manage an active session with a site 30 (FIG. 2) that has been stored with a browser snapshot. As known in the art, the site 30 may include a time-out policy for an active session. Accordingly, a browser snapshot archived for an extended period of time may no longer be restorable as an active session upon retrieval from storage.

In one embodiment the timing component 88 may periodically communicate with (e.g. ping) the site 30 to maintain activity of an active session for which a browser state has been captured and stored. The communication may include simply pinging the site 30, or may include whatever communication is needed to reset the timeout period. Based on the time at which each of the browser snapshots are saved, the timing component 88, may initiate communication to refresh the time-out period of the corresponding site 30.

In another embodiment, the timing component 88 may probe each of the sites 30 associated with a stored browser snapshot for a session time-out value. The user may then be informed by the timing component 88 to retrieve the browser snapshot before a time-out of the corresponding active session occurs. In addition, when the predetermined time is exceeded (or about to be exceeded), the timing component 88 may generate a time-out indication to the user indicating the browser snapshot for which a timeout has occurred (or will occur). In yet another embodiment of the BSR service 10, the time-out policies of the site 30 may be increased to accommodate active sessions for which a browser snapshot has been stored. In still other embodiments, the site 30 may suspend the timeout policy for an active session upon indication by the timing component 88 that a browser snapshot for the active session has been captured and stored.

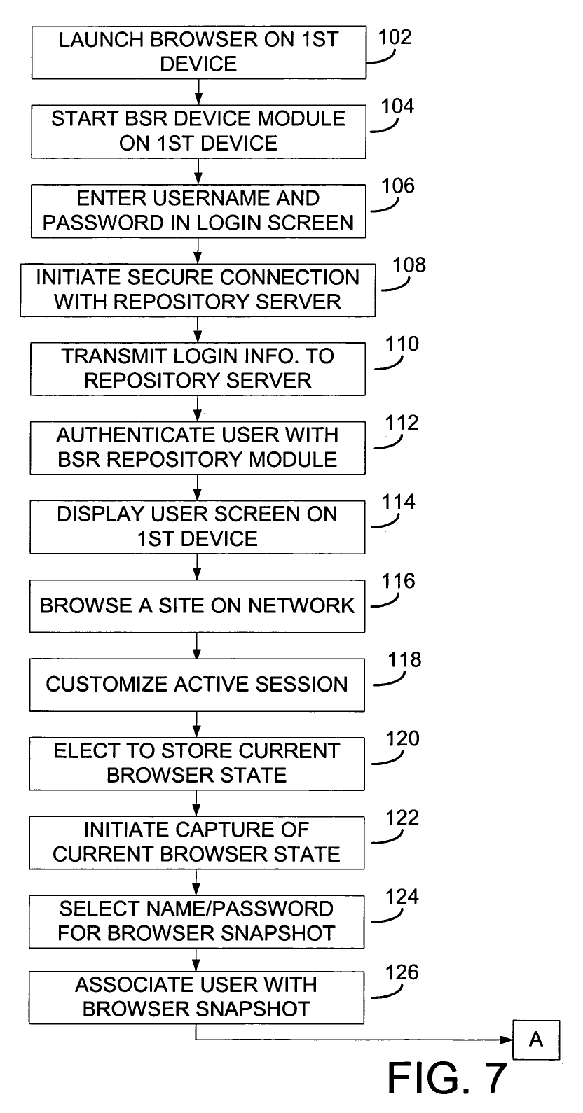

FIG. 7 is a block diagram illustrating operation of one embodiment of the BSR service 10 illustrated in FIGS. 1, 2, 3, 4 and 6. For purposes of this exemplary operational discussion, it is assumed that the user has previously created a user account to obtain access to the BSR service 10. In addition, the user has not yet captured or stored any browser snapshots from previous active sessions.

The operation begins at block 102 where the first browser 20 is launched on the first device 14. At block 104, the BSR device module 34 associated with the first device 14 and the first browser 20 is started. The user may enter a username and password in the login screen of the user interface bar 50 at block 106. At block 108, the BSR device module 34 initiates establishment of a secure connection with the repository server 18. The login information is transmitted over the secure connection to the repository server 18 at block 110. At block 112, the BSR repository module 36 within the repository server 18 may authenticate the user based on the login information and provide an authorization approval message to the BSR device module 34. The login screen is exchanged for the user screen in the user interface bar 50 at block 114. At block 116 the user may use the first browser 20 to locate and begin browsing a site by transmitting a request over the network 12.

The first browser 20 may communicate requests to the site 30 to customize an active session at block 118. Following customization, the user may elect to store the current browser state of the active session at block 120. At block 122, the capture of the current browser state of the active session is initiated by activating the snapshot button 64 in the user interface bar 50. Following capture of the browser state of the active session in a browser snapshot, a session name and password may be selected for the snapshot at block 124. At block 126, the user is associated with the browser snapshot.

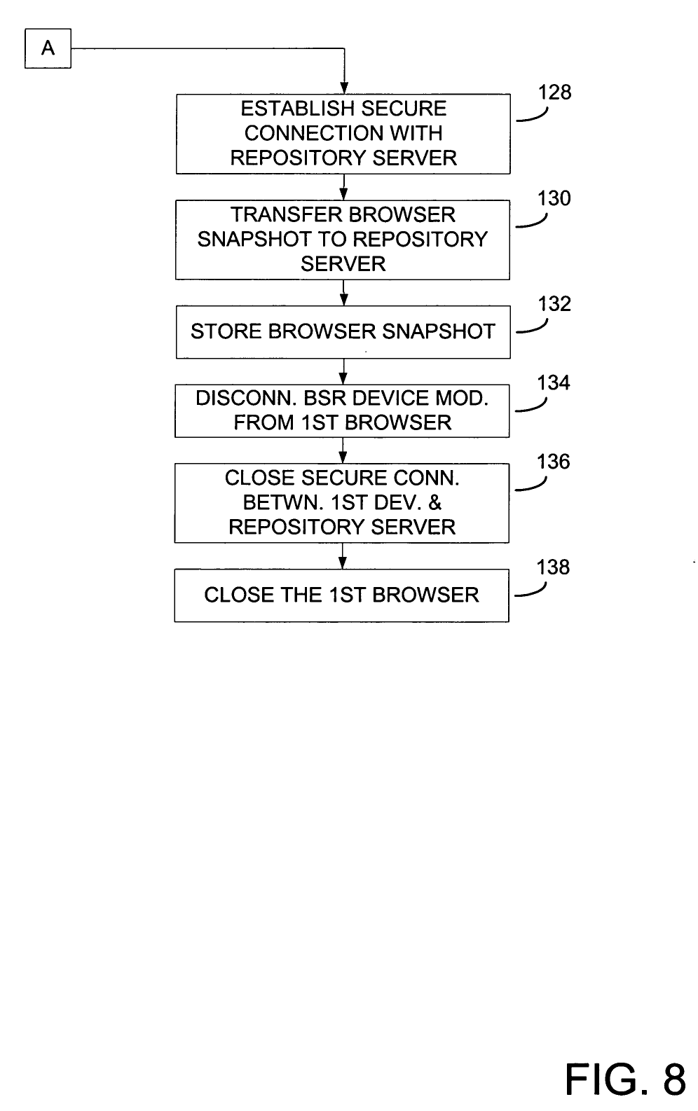

Referring now to FIG. 8, the BSR device module 34 initiates establishment of a secure connection between the first device 14 and the repository server 18 at block 128. Following establishment, the secure connection may be used to transfer the browser snapshot to the repository server 18 at block 130. At block 132, the browser snapshot may be deciphered and stored by the BSR repository module 36 based on the user associated with the browser snapshot. At block 134, the user may elect to end browsing by first activating the sign-off button 74 on the user interface bar 50 to disconnect the first browser 20 from the BSR repository module 34. The BSR repository module 36 closes the secure connection between the first device 14 and the repository server 18 at block 136. At block 138, the user may close the first browser 20.

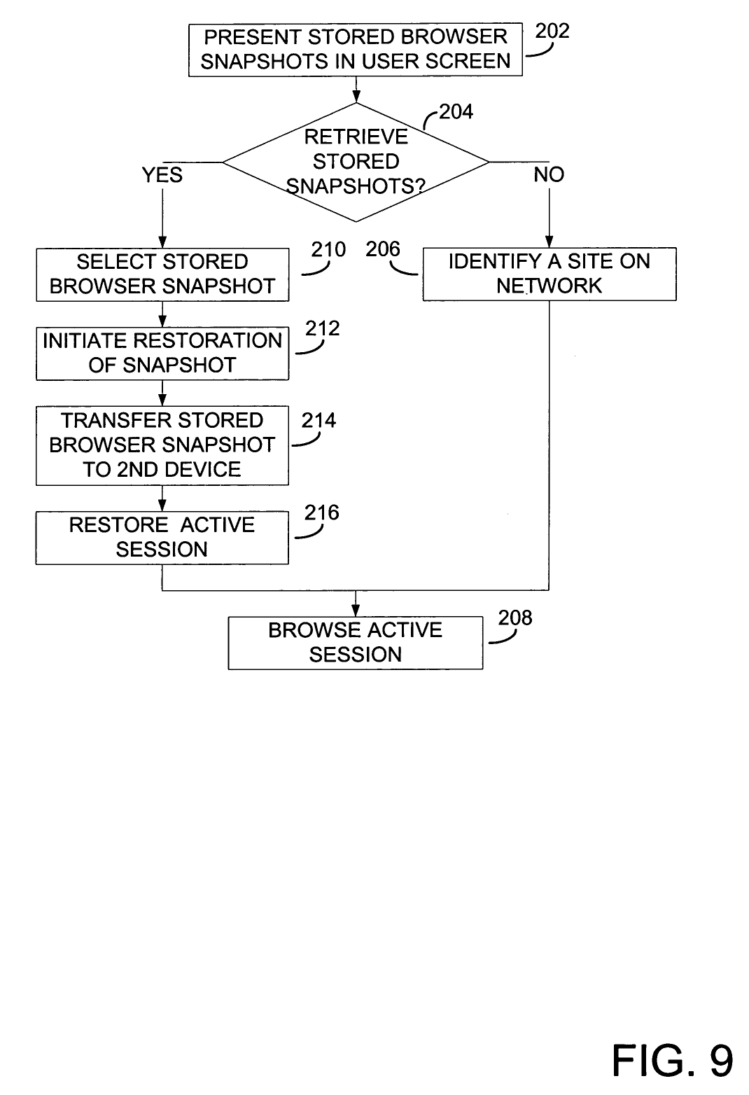

FIG. 9 is a block diagram illustrating operation of one embodiment of the BSR service 10 based on the subsequent launch of the second browser 22 on the second device 16 by the same user. For purposes of this exemplary operational discussion, it is assumed that the user previously stored a browser snapshot using the first browser 20 operating on the first device 14. Although not illustrated, previously described blocks 102 through 114 (FIG. 7) are repeated using the second device 16 in place of the first device 14 and the second browser 22 in place of the first browser 20.

Referring now to FIG. 9, the operation continues at block 202 where a list that includes the previously stored browser snapshot associated with the logged in user is downloaded over a secure connection and presented in the user interface bar 50. At block 204, the user may decide whether to retrieve a stored browser snapshot. If the user elects not to retrieve a stored browser snapshot, the user may use the second browser 22 to identify a site 30 on the network 12 at block 206. At block 208, the user may begin browsing within an active session by transmitting a request over the network 12.

If the user elects to retrieve a stored browser snapshot at block 204, the stored browser snapshot is selected from the session name field 66 and the associated password is supplied in the session password field 68 at block 210. At block 212, the restore button 70 in the user interface bar 50 is activated to initiate the restoration process. Following password verification, the selected stored browser snapshot is downloaded over a secure connection from the repository server 18 to the second device 22 at block 214.

At block 216, the BSR device module 34 restores the stored browser snapshot to re-create the active session in the second browser 22. The second browser 22 may begin browsing the site 30 associated with the restored active session by transmitting a request over the network 12 at block 208.

The remaining operation of the second browser 22 in further customizing and storing a browser state of the active session is similar to the operation previously described with reference to FIGS. 7 and 8. In other embodiments, the user may randomly utilize different devices and different browsers to browse sites as well as randomly customize active sessions, and store associated current browser states. In addition, the user may randomly utilize different devices and different browsers to retrieve and restore stored current browser states and continue the associated active sessions.

The previously discussed embodiments of the BSR service 10 allow a user to migrate among devices in the middle of a customized active session without losing the session and having to start over to re-customize the session on a different device. In addition, a user may keep track of multiple customized active sessions simultaneously by saving and continuing any of the active sessions at any time from any device. Saving an active session with the BSR service 10 simply involves taking a snapshot of the browser state of the current active session. The snapshot may be securely stored, and then later securely retrieved and restored to again be the current active session complete with any previous customization by the user. The user may store and retrieve browser snapshots with any browser and/or device. Accordingly, the BSR service allows association of browser snapshots with users of the BSR service rather than with any browser or device.

In another embodiment, the BSR service is extended to create a Browser Session Mobility (BSM) system. The BSM system may support mobility of runtime states of active sessions of multi-platform network applications between different platforms. As known in the art, a session is an instance of a user using a network application, such as a web application. Each of the platforms may be described as a class of heterogeneous devices having a different software and/or hardware environment, such as, a pocket personal computer (PC), a wireless phone, a desktop computer, etc. As previously discussed, the BSR service may allow a user to save and restore multiple browser snapshots of active sessions by decoupling the association between browser state and a particular device, in favor of a new association between browser state and the user. The BSM system extends this association to include seamless transitions between different platforms upon which the multi-platform network application may operate.

Support of the mobility of the runtime states by the BSM system involves accommodating different platforms. Different platforms may have different limitations and capabilities related to displays, networking, user interfaces, etc. The BSM system provides the capability to capture not only browser state, as was the case with the BSR service, but also the server state of an active session. State data and session data generated within the browser state and the server state of an active session may be collectively referred to as a runtime state. Within the BSM system, the term “state” or “runtime state” refers to the accumulated interactions of a user with a network application. The runtime state may include a browser state, such as form data, script variables, cookies, etc., and a server state supporting the browser state. The server state may differ from platform to platform, such as the state of platform-specific Java server pages (JSP) pages or platform specific computer generated images (CGI).

The BSM system also includes the capability to convert a platform specific runtime state created with a platform specific version of a multi-platform network application to another platform specific runtime state in a different platform specific version of the multi-platform network application. Accordingly, within the BSM system, the runtime state of multi-platform network applications implemented on specific platforms may be transferred to other specific platforms by decoupling the association between the runtime state and each specific platform.

The previously described concept within the BSR service of a snapshot is modified and expanded within the BSM system to include platform-independent runtime state data. Accordingly, a snapshot may be restored to an active session by the BSM system on any platform. The BSM system may operate within the tasks, runtime state and data structure of any platform specific version of a multi-platform network application. Within the structure of any multi-platform network application, the BSM system has the capability to capture, transform from platform to platform, and restore snapshots of active sessions.

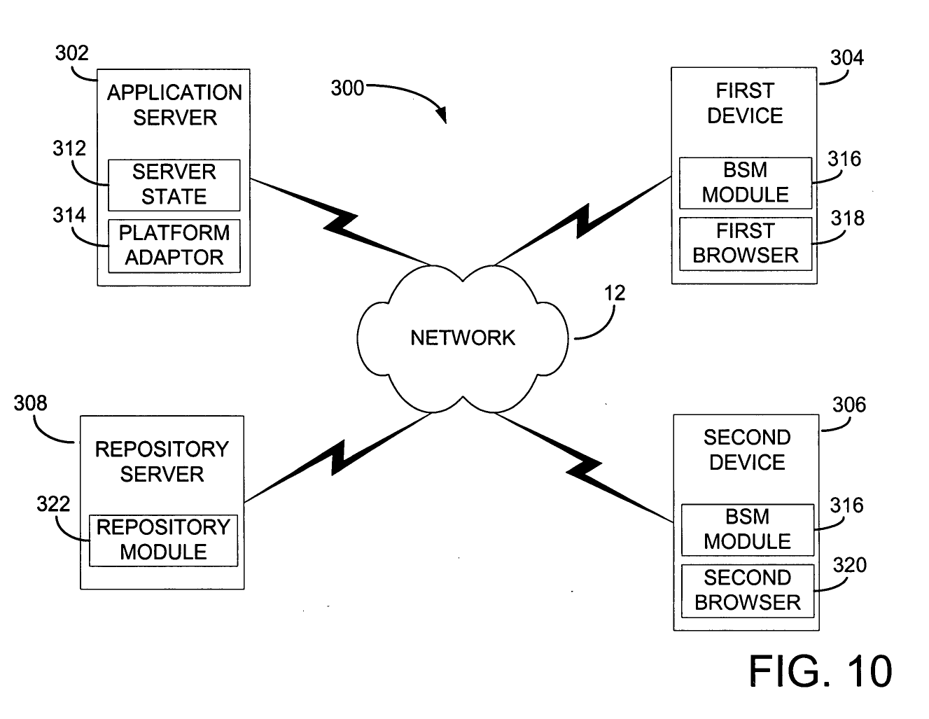

FIG. 10 is an example of the BSM system 300 operating over the previously discussed network 12. The illustrated BSM system 300 includes at least one application server 302, at least one communication device that is depicted as first and second devices 304 and 306 and at least one repository server 308. In other examples, the BSM system 300 may include any number of application servers, communication devices, repository servers and/or any other network compatible devices.

The application server 302 may be any network compatible device(s) capable of serving an application(s) to devices on the network 12, such as the devices 304 and 306. The application server 302 may include a processor, memory, at least one multi-platform network application, such as a multi-platform web application stored in memory, a server state module 312 and a platform adapter module 314. The application server 302 may also include operating systems and programs stored in memory to provide capability similar to a conventional network server computer. Well-known mechanisms for serving network applications over networks involve initiating an active session with the application server 302 with a request, such as a hypertext transfer protocol (HTTP) request.

The request may be communicated over the network 12 to the application server 302 from a target platform such as device 304 or 306. As a function of the request, the application server 302 may determine the type of platform (e.g. a desktop personal computer (PC), a laptop, a pocket PC, a personal digital assistant (PDA), wireless phone, etc.) and the corresponding platform specific version of a multi-platform network application that should be launched for the target platform. The application server 302 may then create a server state with the server state module 312. The server state may operate with a platform specific network application compatible with the target platform. The platform specific network application is the platform specific version of the multi-platform network application that is capable of forming and maintaining an active session within the browser state of the target platform.

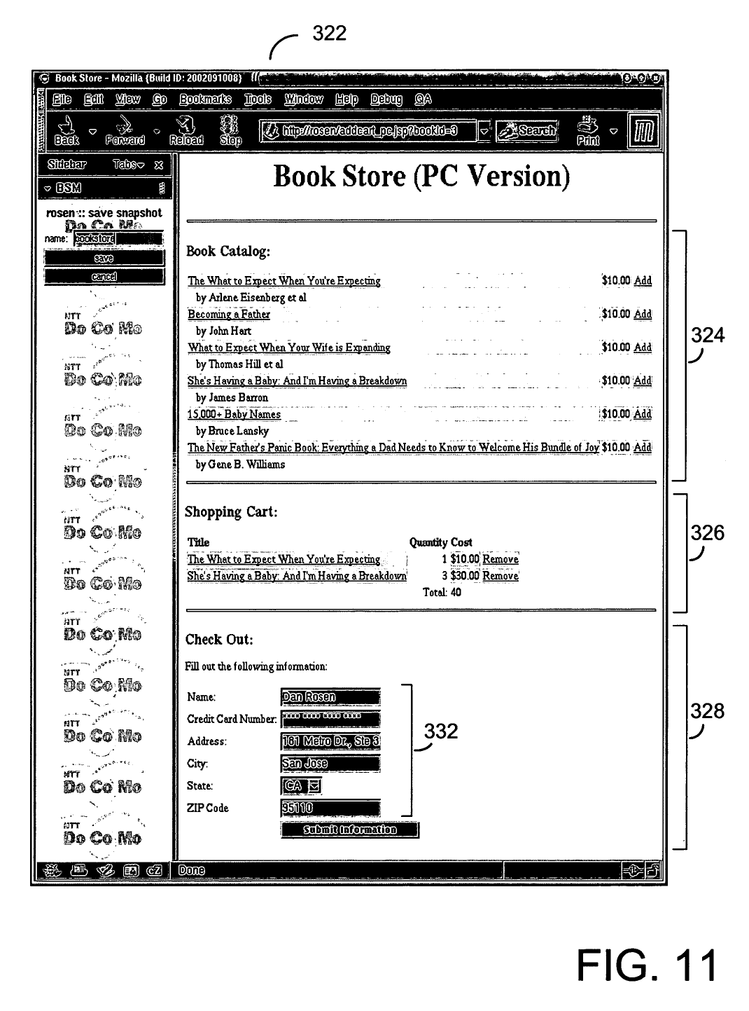

FIGS. 11, 12 and 13 illustrate different example presentations within browser states of different device platforms that are supported by server states operating with respective platform specific versions of a network application. The platform specific versions may be different versions of a multi-platform network application that, in this example, is a bookstore application. The respective examples illustrated in FIGS. 11, 12 and 13 are different platform specific presentations of the bookstore application each optimized for capabilities such as the size of a display screen, user interface controls and the type of network connection of the respective target device platform. The number of different platform specific versions included in the multi-platform network application may be any number in other examples.

As illustrated in FIG. 11, a first example presentation 322 within the browser state of an active session may be generated by a first platform specific version of the bookstore application. The first platform specific version may be designed to maintain an active session for device platforms with a relatively large display screen and a relatively robust network connection such as a desktop PC or a laptop. Since the display screen is relatively large, the platform is capable of displaying a book catalog task 324, a shopping cart task 326 and a checkout task 328 in one presentation within the active session. With a relatively high speed connection to the network 12 and a relatively precise variety of user interface controls, navigation within the active session may include for example, scrolling, mouse clicks, keyboard data entry, etc.

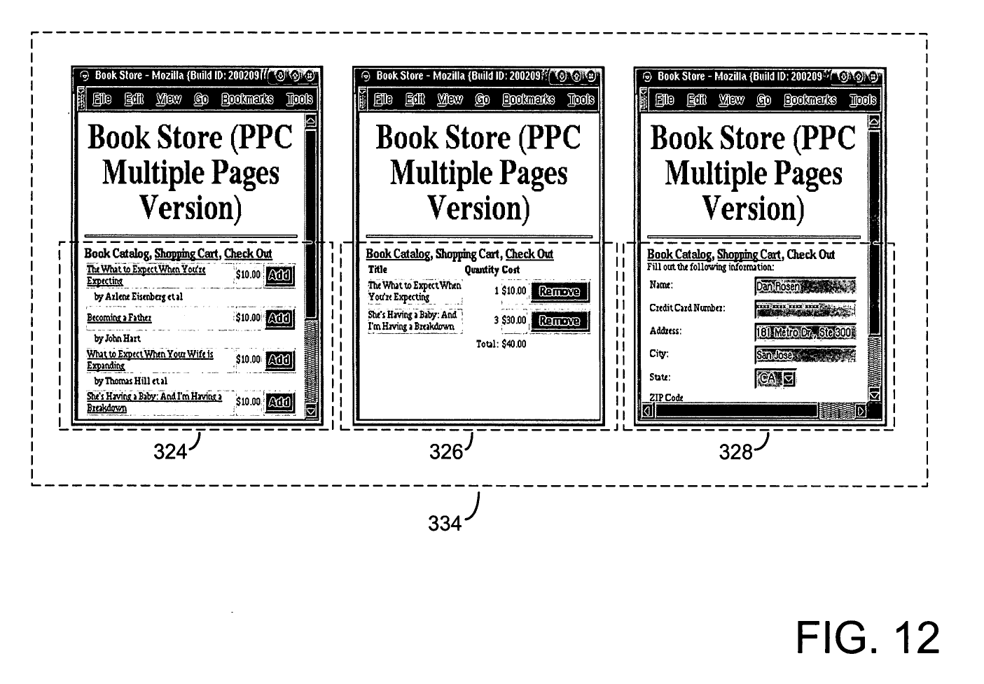

As illustrated in FIG. 12, a second example presentation 334 within an active session may be targeted for device platforms with a relatively high speed connection to the network 12 (FIG. 10) and a smaller display screen such as a Pocket PC or PDA. The active session involving the second presentation 334 may be supported by a second platform specific version of the bookstore application that is designed for such target device platforms. The second platform specific version may arrange the book catalog task 324, the shopping cart task 326 and the checkout task 328 on individual pages within the browser state as illustrated for ease of viewing on the smaller screen. Requests for individual pages, such as HTTP requests, may synchronize the browser state with the server state operating the second platform specific version of the network application.

User interface controls and navigation within the browser state may also be significantly different between different platform specific network versions of the application due to differences in the user controls available. For example, in the first presentation 322 (FIG. 11) the user interface allows the entire tasks 324, 326 and 328 to be displayed. In the second presentation 334 (FIG. 12), only a portion of the tasks 324, 326 and 328 are displayed due to the smaller screen, and therefore a scroll bar 336 is included. Other examples of changes in user interface and navigation among different target device platforms may include converting textfield boxes to an identifier drop-down box cooperatively operating with a single textfield, converting mouse control to touchscreen control, etc.

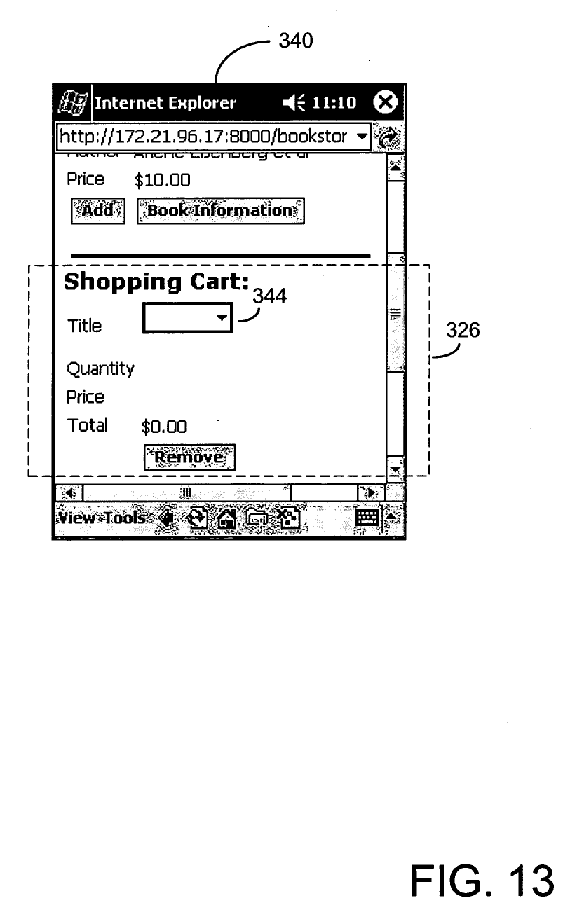

As illustrated in FIG. 13, a third example presentation 340 may be targeted for devices with a relatively small screen and a relatively slow connection to the network 12 (FIG. 10), such as a pocket PC with a poor network connection. The server state may operate with a third platform specific version in support of a browser state that includes the third presentation 340. In this example, the book catalog task 324 (not shown), the shopping cart task 326 and the checkout task 328 (not shown) are arranged in a single presentation with scrolling features. The third platform specific version may present alternative user interface controls in the browser state that allow for easier viewing of the active session with the target device.

For example, in the shopping cart task 326 illustrated in the third presentation 340, navigation to different titles is provided by a title drop down box 344 instead of being presented in a list as in the shopping cart task 326 of the first presentation 322 (FIG. 11) and the second presentation (FIG. 12). In addition, navigation control within the active session may also be performed with client-side scripting at the target device. For example, a “quantity” and “price” may be retrieved based on the title selected with the title drop-down box 344. As such, network traffic may be minimized since fewer requests, such as an HTTP request, may be generated from the browser state and transmitted over the network to the server state.

Due to significant differences in operational presentation and function that may be present, each presentation may implicitly have a different task model. Based on the platform specific version of the network application operated with the server state, data may be displayed and variables containing form data may be submitted to the server side runtime state at different times and in different ways depending on the platform. Accordingly, the data forming the server side runtime state of different platform specific versions of the multi-platform network application may be significantly different.

Referring again to FIG. 10, the platform adapter module 314 may cooperatively operate with the server state module 312. The platform adapter module 314 may include the capability to capture a platform specific (PS) snapshot of a server side runtime state of the current active session from the server state module 312. The server side PS snapshot of an active session may include session specific runtime state data related to the ongoing interaction between a browser and the application server 302 during an active session. The amount, type and detail of session specific server side runtime state data captured in the PS snapshot by the platform adapter module 314 may be specified by application developers of the multi-platform network application. The session specific server side runtime state data captured in the PS snapshot may include connections to other databases, cached data related to the active session, open files, inputs/outputs, JSP or CGI variables, etc. The server side PS snapshot may be transmitted over the network 12 to the first and second devices 304 and 306 and/or the repository server 308 by the platform adapter module 314.

Alternatively, the platform adapter module 314 may also include capability to transform the server side PS snapshot to a server side platform independent runtime state. The transformation may be accomplished through mapping to selectively convert the server side session specific runtime state data to platform independent session specific runtime state data. Similarly, the platform adaptor module 314 may transform platform independent runtime state data to platform specific runtime state data.

Mapping may be performed by the platform adaptor module 314 with mapping description files. The mapping description files may be specified by application developers to describe the transformations between platform specific server side runtime state within PS snapshots and a corresponding server side platform independent runtime state.

The server side platform independent runtime state may be included in a platform independent (PI) snapshot. The platform adapter module 314 may communicate the PI snapshot and the mapping description file over the network 12 to other devices such as the repository server 308 and/or the first and second devices 304 and 306. As in the previous embodiments, communications over the network 12 may be encrypted.

The first and second devices 304 and 306 each include a BSM module 316. Similar to previously discussed devices 14 and 16 (FIG. 1), the BSM module 316 cooperatively operates in the first and second devices 304 and 306 with a first browser 318 and a second browser 320, respectively. The BSM module 316 may be a browser plug-in, a stand-alone module, etc. within the first and second devices 304 and 306.

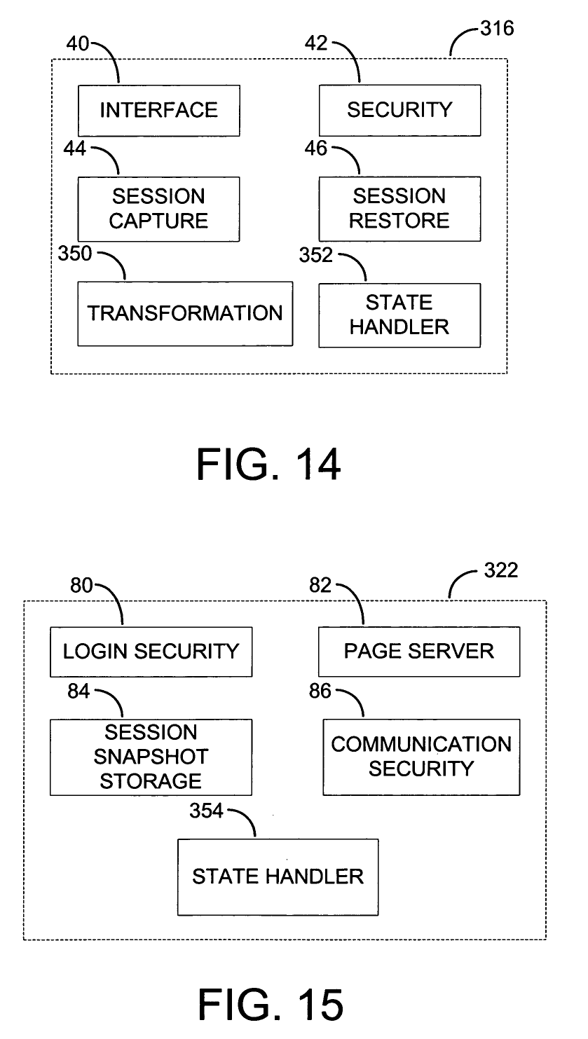

FIG. 14 is a block diagram depicting an example of the functionality of the BSM module 316. In addition to the previously discussed interface component 40, the security component 42, the capture component 44 and the restore component 46, the BSM module 316 also includes a transformation module 350 and a state handler module 352. Browser side platform specific (PS) snapshots captured by the capture component 44, as previously discussed, represent the browser side runtime state of an active session within a platform specific version of a network application. In other examples, the functionality of the BSM module 316 may be described with any number of modules/components.

The transformation module 350 may cooperatively operate with the capture component 44 to selectively transform the browser side runtime state of a platform specific version of a network application (a browser side PS snapshot). Similar to the platform adapter module 314 (FIG. 10), the browser side PS snapshot may be transformed with a mapping description file to create a browser side platform independent runtime state that includes session specific runtime data. More specifically, platform specific runtime state data within the browser side PS snapshot may be selectively transformed to create platform independent runtime state data. The transformation module 350 may also cooperatively operate with the restore component 46 to selectively transform a platform independent browser side runtime state to create a browser side PS snapshot that includes platform specific browser side runtime state data.

Selective transformation of state data by the transformation module 350 may be performed using a mapping description file. Similar to the platform adapter module 314 (FIG. 10), the mapping description file may be specified by application developers to describe selective transformations between platform specific browser side runtime state data within browser side PS snapshots and a corresponding browser side platform independent runtime state data.

Following transformation of the browser side PS snapshot, the state handler module 352 may receive a corresponding platform independent browser side runtime state from the transformation module 350. The state handler module 352 may also receive a PI snapshot that includes the server side platform independent runtime state from the platform adapter 314 (FIG. 10). The server side platform independent runtime state may be aggregated with the browser side platform independent runtime state within the PI snapshot The PI snapshot that includes the platform independent runtime state of the session may be transferred to the repository server 308.

Alternatively, the state handler module 352 may receive a server side PS snapshot from the platform adaptor 314 (FIG. 10). The server side PS snapshot may be transformed with the mapping description file by the transformation module 350. The transformation may be from a platform specific server side runtime state to a platform independent server side runtime state. The platform independent server side runtime state may then be aggregated with the platform independent browser side runtime state by the state handler module 352.

In yet another alternative, the state handler module 352 may receive a server side PS snapshot that includes a platform specific server side runtime state. The state handler module 352 may aggregate the server side PS snapshot with a browser side PS snapshot that includes a platform specific browser side state. The aggregation of the server and browser side PS snapshots may form a platform specific runtime state snapshot. The platform specific runtime state snapshot may then be transmitted over the network 12 to the repository server 308 by the state handler module 352.

For previously saved PI snapshots that are retrieved from storage, the state handler module 352 may receive and extract a platform independent browser side runtime state from such a PI snapshot. The platform independent browser side runtime state may be provided to the transformation module 350 for transformation to a PS snapshot. Following transformation, the now platform specific browser side runtime state may be instantiated in a presentation as an active session.

Referring once again to FIG. 10, the repository server 308 includes a BSM repository module 322. Similar to the previously described repository server 18 (FIGS. 1 and 6), the repository server 308 may cooperatively operate with the first and second devices 304 and 306, as well as the application server 302 over the network 12. Alternatively, the repository server 308 may communicate only with the first and second devices 304 and 306.

FIG. 15 is a block diagram illustrating the functionality of the repository module 322. In addition to the login security module 80, the page server module 82, the snapshot storage module 84 and the communication security module 86 previously discussed with reference to FIG. 6, the repository module 322 may also include a state handler module 354. The state handler module 354 may receive, transform and aggregate the browser side PS snapshot and the server side PS snapshot from one of the devices 304, 306 and/or the application server 302 to create a PI snapshot. In other examples, any number of modules may be used to describe the functionality of the repository module 322.

Alternatively, the state handler module 354 may receive and transform a platform specific runtime state snapshot representative of both the browser state and the server state to the PI snapshot. In another alternative, where the PI snapshot is created with platform adapter 314 of the application server 302 (FIG. 10) or the state handler module 352 (FIG. 14) the state handler module 354 may be absent. In this alternative, the PI snapshot may simply be transmitted to the repository server 308 and stored with the snapshot storage module 84.

It should be noted that the illustrated repository module 322 does not include the timing component 88 (FIG. 6). The timing component 88 may be unnecessary with the BSM system 300 when both the browser side runtime state and the server side runtime state of an active session are captured in a snapshot. Accordingly, time management to maintain the active session with the application server 302 (FIG. 10) may be unnecessary.

Referring again to FIG. 10, during operation, a user may initiate an active session by requesting the launch of a multi-platform network application with a communication device such as the first device 304. A platform specific version of the multi-platform network application may be used within a server state to start and maintain the active session with the first browser 318 operating on the first device 304. While engaged in the active session, the user of the first device 304 may initiate the capture of the active session with the BSM system 300.

PS snapshots may be created to capture the platform specific runtime state of the active session, which may include the capture of a current browser state of the browser operating on the first device 304 and the capture of a current server state of the application server 302. The PS snapshots of the current browser state and server state may be combined and transformed to a PI snapshot that includes a platform independent runtime state representative of the active session. The PI snapshot may be stored in the repository server 308.

The PI snapshot may later be retrieved with a target device such as the second device 306. The PI snapshot may be transformed to PS snapshots based on the hardware and/or software capabilities (platform) of the second device 306. The server side PS snapshot includes a platform specific server side runtime state data, and browser side PS snapshot includes a platform specific browser side runtime statedata. The platform specific runtime states may be instantiated as an active session to continue the previously initiated active session. Instantiation of the active session may involve recreating the previously initiated active session with the application server 302 and the second browser 320 operating on the second device 306. Accordingly, an active session may be restored on any platform.

Transformations within the BSM system 300 address the differences in platform specific runtime states. The transformations may be based on selective mapping between platform specific runtime states and platform independent runtime states. The mapping allows dissimilarities between platform specific applications to be reconciled by the BSM system 300. Because mapping of the components of one platform specific presentation to another platform specific presentation is made tractable by the BSM system 300, seamless bridging between different heterogeneous platforms may occur.

Differences between platforms such as, pagination, user interface (UI) controls, state maintenance and any other platform specific differences may be captured through transformations with the BSM system 300. Pagination refers to how tasks are subdivided or aggregated into pages within an active session. Tasks refer to different functions within an active session, such as searching, purchasing, selecting, etc. that may directed by a user. UI controls refers to controls that may be manipulated by a user, such as a keypad, keyboard, touch screen, mouse, etc. for inputting runtime data and otherwise manipulating an active session. State maintenance refers to how platform specific applications may maintain state between pages, such as database entries, cookies, script variables, hidden form fields, etc., and how the state is synchronized between the browser state and the server state.

The mapping of PS snapshots involves selective mapping of pages and data. Pages may be mapped by abstractly considering each page of a presentation as corresponding to a platform-independent task. As previously described, data may be form controls, cookies, JSP variables, script variables, etc. In one example mapping technique, when mapping datum within a PS snapshot, a unique platform independent name(s) may be selectively assigned to data. The different platform specific data may be mapped with a mapping description file to the assigned unique platform independent name(s) to convert the platform specific data to platform independent data. Similarly, when transforming platform independent data to form a PS snapshot for a particular platform, a mapping description file associated with that particular platform may be used to convert the unique platform independent name to platform specific data within the PS snapshot.

An example implementation of a mapping framework may take the form of one HTML annotation and two simple XML document types. To describe this mapping framework, example operation of the BSM module 316 (FIG. 10) during save and restore of a PI snapshot will be used. An application may be identified as a multi-platform application to the BSM module 316 by a multi-platform identifier. An example multi-platform identifier is a line in the header of each HTML page of a presentation, such as: <link rel=“bsm-map” href=“my-platform.xml”>. In this example, the link element is part of the HTML standard, and is used to specify a relationship between two documents. The relationship may specify that there is a mapping which applies to the page currently being viewed with the browser, and that the mapping is described by a mapping description file (“my-platform.xml” in this example).

The mapping description files are used by the BSM module 316 as instructions for executing the transformations between platform-specific and platform-independent representations of runtime state during the save and restore processes. An example document type definition (DTD) for this type of mapping description file may specify the following structure:
A map element may include a URL reference to a master mapping file (discussed later), and may contain one or more page elements.
A page element may map from a page URL to one or more “tasks,” which are informal, conceptual tasks in the network application. The tasks may contain zero or more control elements.
A control element may map from a platform-specific UI control name to a unique platform independent name, and may contain zero or more value elements.
A value element (session data and/or state data) may map from a platform-specific value, such as a UI control, to a platform independent value representative of the UI control.

Mapping description files may be selectively configured by application developers for each platform specific version of the network application. For example, mapping description files may be developed to explicitly map any range of values (data) in one control, in one page (task) of a first platform specific version, to a different range of values (data) in another control, in another page (task) of a second platform specific version of the network application. The mapping description files may also provide application developers the flexibility to selectively provide mapping for only those controls that do not have the same names and ranges of values among different platform specific versions of the application. Where the controls have the same names and ranges of values in different platform specific versions, no mapping to a unique platform independent name, for example, needs to be specified. If among platform specific versions all of the controls have the same names and ranges of values, developers may need to specify only the page/task mappings in the mapping description files.

The following example maps three pages to tasks, and maps an HTML control (presumably a <select>, or group of <input type=“radio”> elements) to a unique platform independent name and range of values:

<map master=“master.xml”>
<page url=“http://localhost/foo.html” task=“foo”>
<control from=“ab” to=“alphabravo”>
<value from=“a” to=“alpha”>
<value from=“b” to=“bravo”>
<value from=“c” to=“charlie”>
</control>
</page>
<page url=“http://localhost/bar.html” task=“bar”/>
<page url=“http://localhost/baz.html” task=“baz”/>
</map>

The BSM system 300 may also include a master mapping file developed by application developers for each multi-platform network application. The master mapping file describes which platforms correspond to which mapping description files. The BSM system 300 may use the master mapping file during the restoration of a PI snapshot. The master mapping file identifies which mapping description file(s) is to be used to transform the PI snapshot to a browser side PS snapshot and a server side PS snapshot or vice-versa. The PS snapshots may in turn be used to determine what page to load in a presentation of a platform specific version.

Typically, a multi-platform network application may choose presentations based on a launch request. The request may be, for example, a user-agent string sent in an HTTP request. The BSM system 300 may similarly choose a presentation for a migrated runtime state. The choice of presentation may be based on conditions within the active session, a default presentation or any other runtime state related parameters. In one example, techniques similar to those implement for the multi-platform network application to choose presentation may be implemented in the BSM system 300. Accordingly, an example DTD may be:
A master element may contain one or more map elements.
A map element may include a regular expression “regex” to match user agent strings, and a URL reference to match the mapping description file associated with the matching user agents. If multiple “regexes” match a user agent string, the first one in the file may be used.

An example master mapping file may be:

<master>
<map useragent=“windows” url=“pc-map.xml”/>
<map useragent=“pocket” url=“ppc-map.xml”/>
<map useragent=“*” url=“default-map.xml”/>
</master>

In this example master mapping file, all user-agents containing “windows” may be associated with a PC mapping description file, all user-agents containing “pocket” may be associated with a PocketPC mapping description file, and all other user agents may be associated with a default mapping description file.

The previously described mapping and associated transformations may be deployed within the BSM module 316, the platform adapter module 314 and/or the repository module 322. In one example, the mapping may be implemented with code such as, XML. An example application description and mapping description file for mapping a server state PS snapshot to a PI snapshot for the previously discussed bookstore multi-platform network application may be:

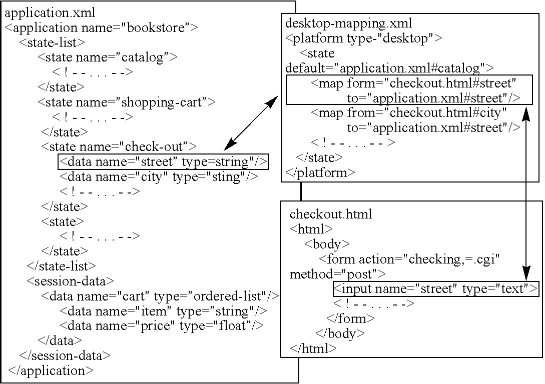

Those skilled in the art would recognize that the above example is not a full-featured implementation, but instead provides an example implementation of mapping within the BSM system 300. In general, the application description and mapping description file describes session data and state data using name/type pairs. In addition, the mapping description file of this example describes data mappings between the application description and an HTML implementation.

Modeling within the BSM system 300 of platform specific presentations may be based on the concept of a finite state machine (FSM). The BSM system 300 may use the finite state machine concept to represent the structure of platform specific presentations within different platform specific versions of a multi-platform network application. The previously discussed mapping may be used in conjunction with the finite state machine models to selectively transform runtime states migrated between different platforms.

Within the BSM system 300, the FSM model may be a directed graph whose edges are ordered pairs of vertices such that each edge can be followed from one vertex to the next. The structure of each platform specific presentation(s) within the platform specific versions of multi-platform network applications may be modeled with a directed graph.

The directed graph formed with the FSM may include vertices indicative of states and edges representative of transitions between states. As used herein, a “state” within an FSM model abstractly represents a task within a platform specific presentation. Transitions between states in the FSM model may represent navigation within the platform presentation(s) of an active session. Navigation involves activities of a user in the active session, such as submitting forms and activating links in a browser. For purposes of saving and restoring the current runtime state of an active session, explicit modeling of transitions with the FSM model may be avoided. Instead, the transitions may be assumed to be implicit in the logic of the platform specific network applications.

Datafields may be associated with each state in the FSM model. The datafields correspond to form controls presented to the user in the platform specific presentation. In addition, state data and session data from the platform specific presentation(s) of the active session may be included in the datafields. The state data may be session specific data representative of task data within the browser state and/or the server state. The session data may be persistent from state to state for the duration of an active session, for example, the contents of a “shopping cart”, cookies, etc.

The FSM models may be used to represent the entire structure of presentation(s) associated with individual active sessions of platform specific versions of network applications. Each platform specific version of the browser side runtime state and the server side runtime state of an active session may also be included within the platform specific presentation(s) represented by FSM model(s).

For example, referring again to the example platform specific presentations in FIGS. 11, 12 and 13, different FSM models may be used to represent the structure of the illustrated browser side versions of a multi-platform network application. A state within an FSM model may represent a page designed specifically for that platform within the browser of an active session. For example, the second presentation 334 of FIG. 12 is illustrated to include three states (324, 326 and 328). The data fields of the FSM models may include representation of the state data and session data generated by a user within the browser during the active session (e.g. the browser side runtime state). For example, unsubmitted checkout information such as name, etc. may be included in the browser side runtime state as state data of the platform specific presentation.

Similarly, platform specific concrete realizations of the server side may be represented by FSM model(s). The data fields of the FSM model on the server side may similarly represent state data and session data (e.g. the server side runtime state). For example, the database from which the book catalog requested by the user was accessed may be part of the state data.

Mapping with mapping description files allows selective transformation of the platform specific state and data fields represented within each platform specific FSM model between a platform independent state and a platform specific state. The mapping may provide decoupling of the active runtime state from the platform the user is currently operating. In addition, the mapping may model the differences in UI controls and pagination between different platform specific versions of a multi-platform network application. For example, the data fields may represent controls selectively presented to the user within each task of an active session based on the different platform specific versions of network applications. The controls may also be handled by logic within individual platform specific network applications.

The BSM system may also identify which state (e.g. presentation) within a platform specific version of a network application a user is in during an active session at the time of a PI snapshot save operation. Accordingly, identification of the state a user is in may be migrated with the runtime state between platform specific versions of a network application. When the PI snapshot is retrieved and restored, the active session may be restored such that the user is presented with the same state (including the runtime data) as when the PI snapshot was saved.

Identification of the state occupied by a user at the time of the PI snapshot save may be a relatively simple two-step process. The first step involves identifying partially-filled data fields in a page of a presentation by reviewing the state of the corresponding FSM model representing the structure of the presentation. Where there are no partially-filled data fields or multiple partially-filled data fields, a specified default state may be identified by application developers as the state occupied by the user.

During a PI snapshot restore, the platform state a user was in at the time of a snapshot save operation is similarly determined. If only a portion of data fields of a state of an FSM model for a first platform specific presentation are filled with data, the BSM system may identify the state. From the determined state, a corresponding state of a second platform specific presentation may be identified and the associated presentation may be displayed when the active state is re-instantiated. Where multiple or no partially-filled state(s) are present, default mapping may be used to identify the state.

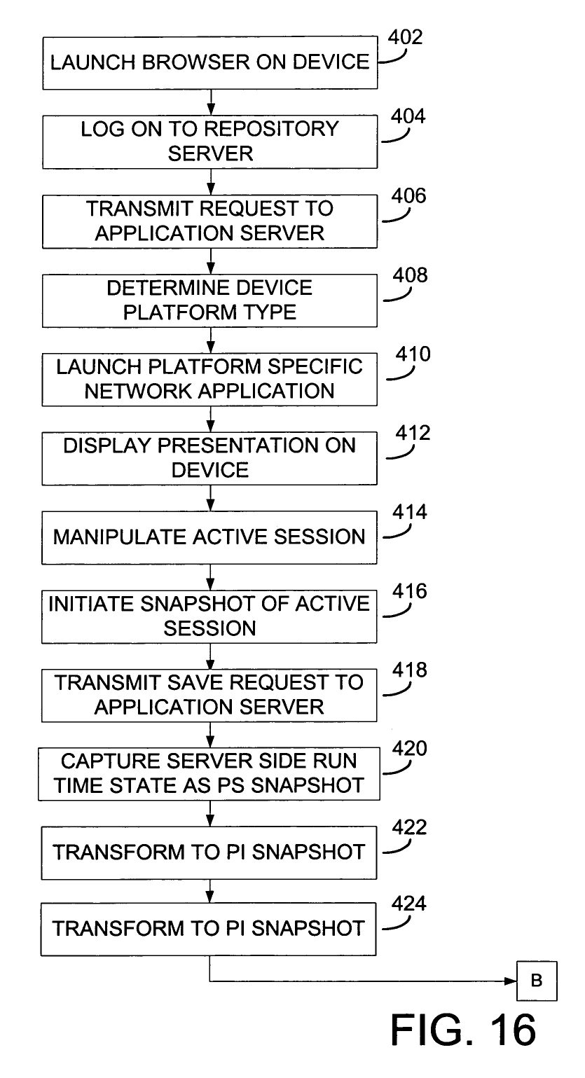

FIG. 16 is a block diagram illustrating example operation of the BSM system 300 illustrated in FIG. 10 to save a PI snapshot representative of an active session. The operation begins at block 402 when a user launches a first browser on the first device 304. The user logs on to the repository server 308 with the first device 304 at block 404. At block 406, the user transmits a request to begin an active session to the application server 302 with the first device 304.

The application server 302 determines the platform type of the first device 304 at block 408. At block 410, the applicable platform specific version of the multi-platform network application that should be utilized with the platform of the first device 304 is launched by the application server 302. The browser of the first device 304 displays the presentation at block 412. At block 414, a browser side state and a server side state are established as the user manipulates the active session. The user initiates capture of a snapshot of the active session with the first device 304 at block 416.

The BSM module 316 in the first device 304 transmits a “save” request over the network 12 to the platform adapter module 314 at block 418. The “save” request may be a resource locator, such as a uniform resource locater (URL), with at least one encoded parameter for identifying the platform of the first device 304. The platform adapter module 314 captures the server side runtime state (state data and session data) of the active session as a server side PS snapshot at block 420. At block 422, the master mapping file is utilized to determine the mapping description file that corresponds to the platform identified in the save request. The server side PS snapshot is selectively transformed to a PI snapshot utilizing the identified mapping description file at block 424.

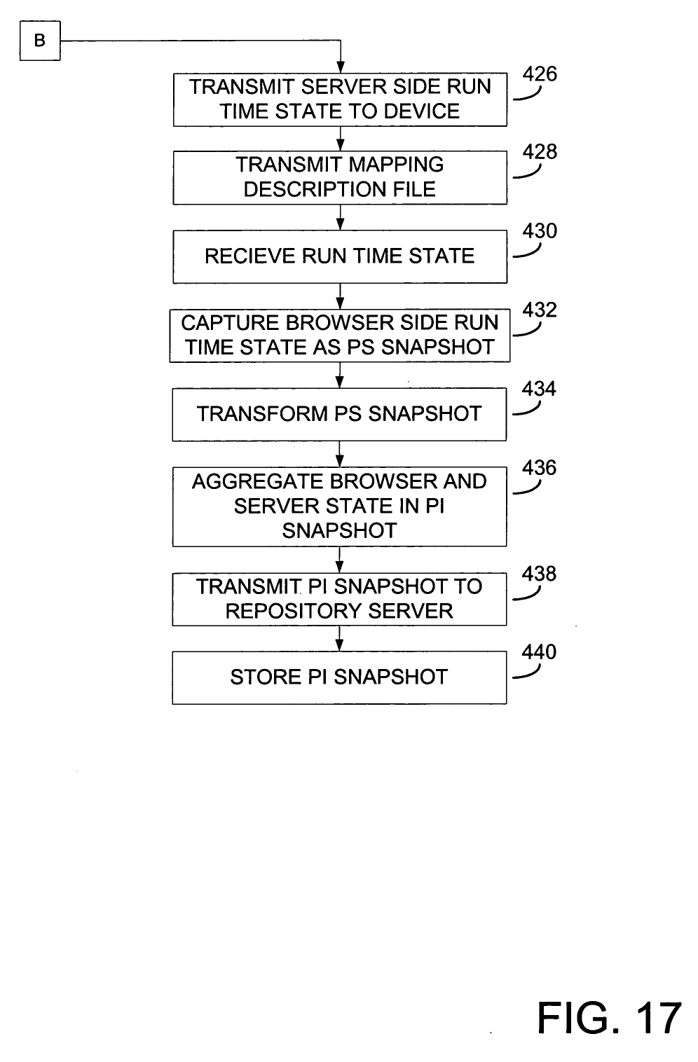

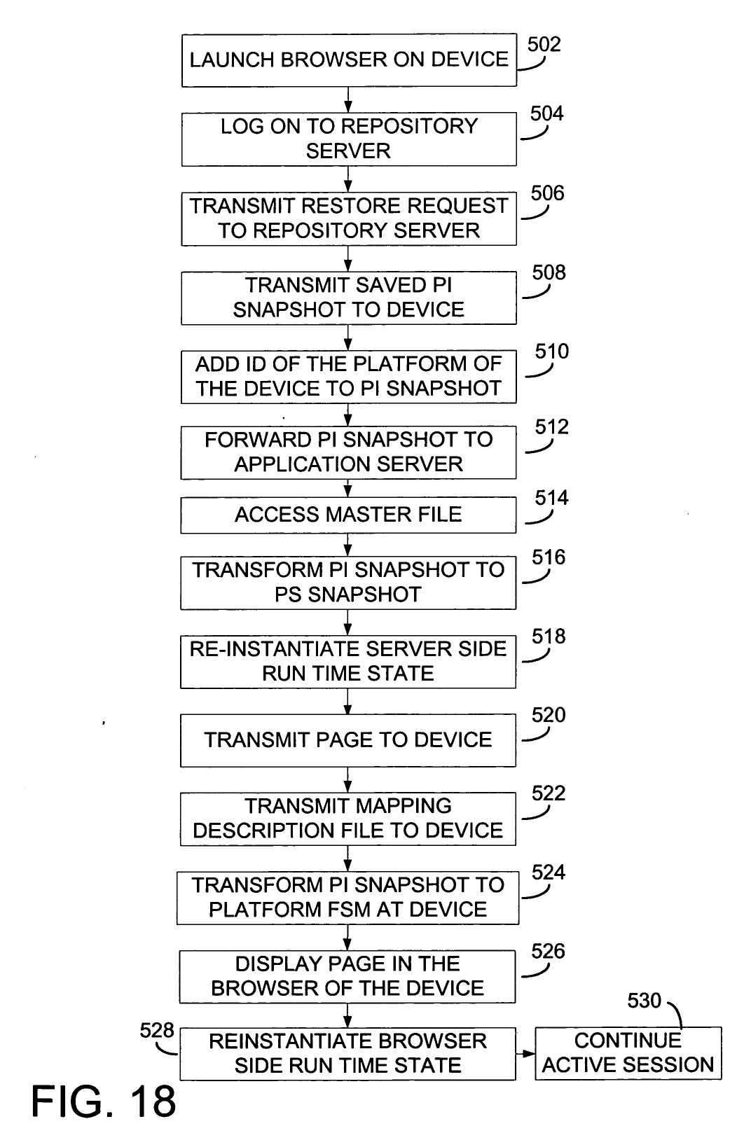

The operation continues in FIG. 17 at block 426 where the platform adapter module 314 transmits the PI snapshot to the first device 304 as a response to the request. In addition, at block 428, the identified mapping description file is transmitted to the first device 304 as part of the response to the request. The BSM module 316 receives the PI snapshot that includes the platform independent server side runtime state at block 430. At block 432, the BSM module 316 captures the browser side runtime state as a browser side PS snapshot. The BSM module 316 utilizes the mapping description file to selectively transform the PS snapshot to a platform independent browser side runtime state at block 434. At block 436, the platform independent browser side running state and the platform independent server side running state are aggregated within the PI snapshot received from the application server 302. The PI snapshot representing the platform independent runtime state of the active session is serialized and transmitted to the repository server 308 at block 438. At block 440, the repository server 308 saves the PI snapshot.

In other operational examples, transformation of the both the browser side state and the server side state may occur at either the application server 302 or the first device 304. In another example, the repository server 308 may utilize a mapping description file(s) to selectively transform PS snapshots transmitted over the network 12 to the repository server 308 from each of the application server 302 and the first device 304. In still another example, the server side PS snapshot may be transmitted from the application server 302 to the first device 304 and the first device 304 may transmit both the browser side and the server side PS snapshots to the repository server 308 for transformation to create the PI snapshot. As is readily apparent transformation with a mapping description file(s) to create the PI snapshot may occur anywhere in the BSM system 300.

FIG. 18 is a block diagram illustrating example operation of the BSM system 300 illustrated in FIG. 10 during the restoration to an active session of the PI snapshot saved with the first device 304 as described in FIGS. 16 and 17. The operation begins at block 502 when a user launches a browser on a communication device, such as the second device 306. For purposes of illustration, we will assume the second device 306 is operating with a different platform than the first device 304. The user logs on to the repository server 308 with the second device 306 at block 504. At block 506, the user elects to restore a saved PI snapshot of an active session and transmits a “restore” request over the network to the repository server 308. At block 508, the repository server 308 transmits the saved PI snapshot over the network 12 to the second device 306 in response to the restore request.

The identification of the platform of the second device 306 is included in a reactivate session request at block 510. The “reactivate session request” may include a resource locator, such as a uniform resource locator (URL), with at least one encoded parameter identifying the state of the presentation to be displayed with the second device 306. The second device 306 forwards the saved PI snapshot to the application server 302 in the “reactivate session request” at block 512. At block 514, the platform adapter 314 accesses the master mapping file to identify the mapping description file corresponding to the platform of the second device 306. The platform adaptor 314 transforms the server side runtime state included in the PI snapshot to a server side PS snapshot with the identified mapping description file at block 516. At block 518, the platform adapter 314 re-instantiates the server side of the runtime state from the server side PS snapshot. At block 520, the platform adapter 314 responds to the reactivate session request with a page of the re-activated active session corresponding to the state of the presentation identified in the reactivate session request.

The platform adapter 314 also transmits the identified mapping description file to the second device 306 as part of the response at block 522. At block 524, the BSM module 316 in the second device 306 transforms the PI snapshot to a browser side PS snapshot using the mapping description file. The browser of the second device 306 displays the page from the application server 302 at block 526. At block 528, the BSM module 316 re-instantiates the browser side of the runtime state which includes filling forms in the displayed page with data, reinitializing scripting variables, cookies, etc. The snapshot is now completely reloaded and the user uses the browser on the second device 306 to continue the active session from the point of the previous snapshot save at block 530. In other examples, the PI snapshot may be transformed to a PS snapshot with a mapping description file(s) in other devices within the BSM system 300.

Referring again to FIG. 10, in another example, the BSM system 300 may create snapshots of only the browser side runtime state similar to the previously discussed BSR system 10. The BSM system 300, however, provides the additional capability of mapping to transform the runtime state between a browser side platform specific (PS) snapshot and platform independent (PI) snapshot as previously discussed. As such, differences in pagination, UI controls and application state between different platforms operating different versions of a multi-platform network application may be seamlessly bridged with the BSM system 300. The BSM system 300 still provides a flexible framework that allows application developers to selectively specify mappings of the browser side runtime state between browsers operating on different platforms.

In this example, the application state maintained on the server side is not captured, transformed or stored. Consequently, when the server expires a user's session, the PI snapshot stored by the BSM system 300 becomes invalid. To avoid expiration of a stored session, the repository server 308 may also include the timing component 88 (FIG. 6). As previously discussed with reference to FIG. 6, the timing component 88 may manage the active session once a PI snapshot is stored. Alternatively, the time out of the active session may be extended or suspended when a PI snapshot is stored.

Since the server side runtime state is not captured, where the provider of the BSM system 300 is not the provider of the application server 302, undesirable exposure of the application server 302 internals is avoided. More specifically configuration of the application server 302 to permit modification of variables, such as arbitrary variables in CGI scripts to accommodate all popular programming languages and server environments, may be avoided. Additionally, the possible security risk associated with exposing the internals of the application server 302 to the outside world is avoided. Further, roaming use of multi-platform network applications may be implemented with the BSM system 300 by application developers with less effort when only mapping for the browser side is desired.

The previously discussed BSM system 300 provides for the capture, storage and restoration of an active session on any platform and any browser. By capturing the runtime state of a platform specific version of a multi-platform network application and transforming the runtime state to a platform independent representation of the runtime state, a platform independent runtime state may be stored. Similarly, the platform independent runtime state may be retrieved and transformed to a different platform specific runtime state for use in a different platform utilizing a different platform specific version of the multi-platform network application. Accordingly, the association between the runtime state and a platform is decoupled. In addition, since the runtime state may include both the server side and the browser side of the runtime state of the active session, the active session may be stored indefinitely and then restored complete with all the state and session data from the active session. Alternatively, only the browser side runtime state may be stored, which still enables decoupling of the runtime state and a specific platform.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method of transferring the runtime state of an active session established with a browser between platform specific versions of a multi-platform network application, the method comprising:
capturing a current browser side runtime state of a platform specific version of a multi-platform network application;
selectively transforming the browser side runtime state to a platform independent runtime state; and
storing the platform independent runtime state.

2. The method of claim 1, further comprising:
capturing a server side runtime state of the platform specific version of the multi-platform network application;
transforming the server side runtime state to a platform independent runtime state; and
storing the server side runtime state with the browser side runtime state.

3. The method of claim 1, further comprising restoring the browser side runtime state on a different platform specific version of the multi-platform network application with the platform independent runtime state.

4. The method of claim 1, wherein capturing the current browser side runtime state comprises capturing state data and session data representative of the runtime state of an active session.

5. The method of claim 1, wherein transforming the browser side runtime state comprises directing the mapping of the browser side runtime state that is platform specific to a browser side runtime state that is platform independent.

6. The method of claim 1, wherein transforming the browser side runtime state comprises selectively converting at least one of state data and session data that is platform specific to corresponding platform independent state data and session data.

7. A method of transferring the runtime state of an active session established with a browser between platform specific versions of a multi-platform network application, the method comprising:
generating a first platform specific snapshot representative of state data and session data of at least one of a browser state and a server state of a first platform specific version of a network application;
converting the first platform specific snapshot to a platform independent snapshot;
converting the platform independent snapshot to a second platform specific snapshot representative of the state data and session data; and
re-instantiating at least one of the browser state and the server state on a second platform specific version of the network application with the second platform specific snapshot.

8. The method of claim 7, wherein generating the first platform specific snapshot comprises capturing both the server state and the browser state each with a different platform specific snapshot.

9. The method of claim 7, wherein generating the first platform specific snapshot comprises capturing at least one of a document object model, a scripting object, a browser history, a browser cache and a cookie.

10. The method of claim 7, wherein converting the first platform specific snapshot comprises selectively mapping at least one of the state data and session data to unique platform independent names to create the platform independent snapshot.

11. The method of claim 7, wherein converting the first platform specific snapshot comprises transforming runtime state data of the first platform specific snapshot to runtime state data of the platform independent snapshot as a function of a mapping description file.

12. The method of claim 7, wherein converting the first platform specific snapshot comprises:
accessing a master mapping file to identify a mapping description file; and
selectively transforming the first platform specific snapshot with the identified mapping description file to create the platform independent snapshot.

13. The method of claim 7, wherein converting the first platform specific snapshot comprises modeling the structure of a platform specific presentation of the first platform specific version of the network application and the structure of a platform specific presentation of the second platform specific version of the network application with respective finite state machine models.

14. A method of transferring the runtime state of an active session established with a browser between platform specific versions of a multi-platform network application, the method comprising:
capturing a first platform specific runtime state of an active session from a first platform specific version of a network application, wherein the active session includes at least one of a current browser state and a current server state;
transforming the first platform specific runtime state to a platform independent runtime state;
storing the platform independent runtime state;
retrieving the stored platform independent runtime state;
transforming the platform independent runtime state to a second platform specific runtime state; and
instantiating the second platform specific runtime state as the active session of a second platform specific version of the network application.

15. The method of claim 14, wherein capturing the first platform specific runtime state comprises extracting a page and data of the active session of the first platform specific version of the network application from a browser presentation.

16. The method of claim 14, wherein transforming the first platform specific runtime state comprises mapping the transformation of at least a portion of a platform specific snapshot to create a corresponding platform independent snapshot.

17. The method of claim 14, wherein transforming the platform independent runtime state comprises mapping at least a portion of the platform independent runtime state to the corresponding second platform specific runtime state.

18. The method of claim 14, wherein capturing the first platform specific runtime state comprises identifying partially filled data fields in a page of a presentation to indicate the state a user occupied at the time of the capture.

19. The method of claim 14, wherein transforming the first platform specific runtime state to a platform independent runtime state comprises selectively mapping data in the first platform specific runtime state to a unique previously assigned platform independent name to the create the platform independent runtime state.

20. The method of claim 14, wherein instantiating the second platform specific runtime state comprises displaying the identified state within the active session of the second platform specific version of the network application.

21. A browser session mobility system for transferring an active session established with a browser between platform specific versions of a multi-platform network application, the browser session mobility system comprising:
a network application server;
a communication device in communication with the network application server, wherein the network application server is operable to serve a platform specific version of a network application to a browser of the communication device to form an active session; and
a repository server in communication with at least one of the communication device and the network application server,
wherein the runtime state of the active session is captured and transformed to a platform independent runtime state with at least one of the communication device, the network application server and the repository server.

22. The browser session mobility system of claim 21, wherein the repository server is operable to store the platform independent runtime state.

23. The browser session mobility system of claim 21, wherein the captured runtime state includes at least one of a current server side runtime state and a current browser side runtime state of the active session.

24. The browser session mobility system of claim 21, wherein the active session is captured in a platform specific snapshot.

25. The browser session mobility system of claim 21, wherein the runtime state of the platform specific version of the network application is transformed to create a platform independent snapshot.

26. The browser session mobility system of claim 21, further comprising a second communication device in communication with the network application server and the repository server, wherein the platform independent runtime state is retrievable from the repository server to re-instantiate the same active session between the network application server and the second communication device.

27. The browser session mobility system of claim 21, wherein the network application server includes a platform adaptor module that is operable to capture and reinstantiate a server side runtime state of the active session.

28. The browser session mobility system of claim 21, wherein the communication device includes a browser session mobility module that is operable to capture and reinstantiate a browser side runtime state of the active session.

29. The browser session mobility system of claim 28, wherein the browser session mobility module is a browser plug-in.
